(19) United States
(12) Patent Application Publication
(10) Pub. No.: US 2026/0029550 A1
(43) Pub. Date: Jan. 29, 2026

(54) GEOLOGY-BASED FACIES TREND MODELING FOR HYDROCARBON EXTRACTION

(71) Applicant: Saudi Arabian Oil Company, Dhahran (SA)

(72) Inventors: Xingquan Zhang, Dhahran (SA); Abdullah S. Alqasem, Dhahran (SA)

(21) Appl. No.: 18/782,639

(22) Filed: Jul. 24, 2024

(51) Int. Cl. G01V 1/30; E21B 47/002; G06T 17/00

(52) U.S. Cl. CPC G01V 1/306; E21B 47/002; G06T 17/00

(57) ABSTRACT

Methods and systems are configured for accessing a three-dimensional (3D) facies model including a set of layers, each layer including boundaries data representing initial facies boundaries for a set of facies represented in that layer; accessing geological constraints data representing facies trends for the set of facies represented in the facies model; for each layer: for each facies type in the layer, determining, for a portion of the layer, a distance from the portion of the layer to a facies boundary for that facies type in the layer; and based on the distance for each facies type and the facies trends represented in the geological constraints data, determining a facies probability value; stacking the layers each including facies probability values for each facies type represented in that layer; simulating facies trends for each facies type; and generating a 3D facies trend model including the simulated facies trends.

### TECHNICAL FIELD

The present disclosure generally relates to determining subsurface properties of a reservoir in a geological region to facilitate extraction of hydrocarbons. Specifically, the present disclosure relates to predicting facies trends in the reservoir by recovering missing facies data associated with porosity wells in the reservoir.

### BACKGROUND

A reservoir in a geological region can include one or more wells that are drilled into the subsurface of the reservoir. The one or more wells can be configured to gather well log data at locations in which the one or more wells are drilled. The well log data may represent facies of the rock at or near the one or more wells that are drilled. Rock facies encompasses all the characteristics of a rock including its chemical, physical, and biological features that distinguish it from adjacent rock.

### SUMMARY

This disclosure describes methods and systems for reconstructing a geological history for a region to assist with well placement in a reservoir in the region. A data processing system is configured to generate, from sequence stratigraphy knowledge for the region, a facies trend model that represents the geological history for the region and enables well placement in the reservoir to maximize or increase production of hydrocarbons.

Facies are classifications of rock or subsurface material that represents a character of the subsurface material (e.g., the rock) expressed by the material's formation, composition, and content. More generally, the characteristics of facies type can include any observable attribute of rocks (such as their overall appearance, composition, or condition of formation) and the changes that may occur in those attributes over a geographic area. A facies encompasses all the characteristics of a rock including its chemical, physical, and biological features that distinguish it from adjacent rock.

The facies trend model generates facies boundaries using distance probabilities functions that are based on the established facies trends. The facies model allows for efficient well location selection and extraction of natural resources such as hydrocarbons. The facies trend model is configured to capture the vertical variations of facies. The facies trend model is configured to enable a prediction of a high-low trend for facies in the region. The high-low trend, or a high-low percent, includes a statistical breadth indicator for defining a path of least resistance representing trend changes over time. The high-low trend and vertical variations of facies together represent a three dimensional (3D) layout or map of facies in the region. The data processing system can use the 3D map of the facies to select locations for drilling wells and cause drilling of wells at those locations.

The described implementations can provide various benefits. Facies models can provide a spatial representation of sedimentary environments that are used for reservoir characterization, fluid flow predictions, historical reconstructions, and decision-making in the exploration and production of natural resources. The geological history is manifested through spatial trends in deposits properties, which must be reproduced in any legitimate model of heterogeneity. In some examples, geostatistics reproduces the sample data, that data's distribution, and the model of spatial correlation. However, there are often too little data to satisfactorily reproduce the spatial trend. Geostatistical workflows can be modified to explicitly account for the trend. In some examples, geostatistical facies trend mapping involves analyzing spatial variations in geological facies to understand the facies trends within a region. This process of facies trend mapping can utilize geostatistical methods like kriging to interpolate and model facies distribution for identifying patterns and trends in subsurface characteristics. However, facies evolution history is difficult to reproduce by using conventional geostatistical tools. The historical perspective helps in understanding how landscapes, climates, and sea levels have evolved, contributing to knowledge of Earth's geological past, and helping to make better prediction of facies distribution and therefore reservoir properties.

In some implementations, distributions of carbonate reservoir facies can be predicted based on geological knowledge with a specific conceptual model. However, determining facies distributions from well logs data is difficult because well data are sparse and do not represent variation for the whole reservoir. 2D trend maps are coarsely estimated by a sedimentologist to predict facies distributions. The coarse estimation includes a set of polygons representing facies boundaries. The 2D trend maps are facies boundaries projected vertically onto a plane. Some facies might be abundant on the upper zone of a formation, while others might be abundant on the lower zone instead. However, the projected 2D trend map removes data for discerning where the abundance is. Some facies might present higher probability inside a polygon, and others may not. Many geo-modelers just use those polygons as facies hard boundaries and apply them to the whole zone, resulting in a facies model that cannot represent the geological reality. Such facies models prevent generation of accurate reservoir properties models, and the predictive power of geological models is totally lost.

To overcome these issues, this disclosure describes a process that incorporates sequence stratigraphy to model facies trends. Sequence stratigraphy controls the distribution of sedimentary facies within a geological sequence. To incorporate sequence stratigraphy into a facies trend model, the data processing system analyzes vertical and lateral relationships of sedimentary rocks to determine depositional and erosional processes in the rock over time. Facies distribution is further influenced by factors such as sea level changes, sediment supply, and basin subsidence. The sequence-stratigraphic-driven facies historical trend modeling approach described herein integrates the sequence stratigraphy data by utilizing a conceptual facies trend model to create a facies trend model that accurately reconstructs geological history.

As described previously, the accurate characterization of facies in a reservoir enables efficient well location selection and extraction of natural resources such as hydrocarbons, as rock most likely to include high quantities of extractable hydrocarbons can be selected for drilling. Specifically, the facies model provides a representation of the spatial and temporal distribution of different rock types and sedimentary deposits within a geological formation. The representation of the spatial and temporal distribution of different rock types enables the data processing system to perform reservoir characterization. For example, the data processing system can use the facies model to characterize subsurface reservoirs by representing the spatial distribution and heterogeneity of different sedimentary facies. The data processing system can estimate at locations throughout the reservoir a reservoir quality. The reservoir quality includes parameter values that represent a storage, distribution, and flow of fluids of hydrocarbons or other resources that occur within the reservoir.

The facies trend model can enable the data processing system to generate prediction data of fluid flow in the reservoir. For example, understanding the distribution of facies is vital for predicting fluid flow within reservoirs. Variations in porosity and permeability associated with different facies impact the movement of fluids, such as oil, gas, or water. Accurate facies models enable better predictions of fluid flow behavior during production or injection scenarios for hydrocarbon wells.

The facies trend model can enable the data processing system to reconstruct a geological history of a reservoir (or other environment) by depicting an evolution of depositional environments over time. The historical context provided by the reconstruction enables the data processing system to interpret a stratigraphy of the reservoir, identify key surfaces in the reservoir, and identify depositional processes that shaped the sedimentary sequence. These data enable the data processing system to improve predictions of well production at a given location in the reservoir relative to a prediction without these data.

The data processing system uses the facies trend model for reservoir simulation. The facies model provides inputs for reservoir simulation. For example, facies models provide a geological framework, allowing the data processing system to simulate fluid flow, pressure changes, and production scenarios throughout the subsurface of the reservoir. The accurate representation of facies variations enhances a reliability of simulation results generated by the data processing system.

The data processing system uses the facies trend model to estimate geological uncertainties and risks associated with exploration or reservoir development. By incorporating facies variability, the data processing system can predict anomalies related to reservoir heterogeneity, seal integrity, and fluid migration.

The data processing system can optimize well placement in the reservoir based on the data provided by the facies trend model. Specifically, the data processing system can use the facies trend model to identify favorable zones to prioritize for drilling. The data processing system, based on the distribution of facies, can generate an improved spacing and positioning of wells to maximize hydrocarbon recovery and minimize risks associated with non-productive zones.

The data processing system can use facies trend models to generate resource estimation data. The data processing system can generate a more accurate estimate of resource volumes within a reservoir. By accounting for variations in facies properties, such as porosity and permeability, the data processing system quantifies potential reserves and estimates a viability of a hydrocarbon or mineral deposit.

An example technical advantage described herein is that the data processing system incorporating statistical approaches to generate the geostatistical facies models. The data processing system enhances an accuracy of predicting facies distribution in areas with limited data. The data processing system can provide new data for regions in which the spatial arrangement of rock types is used for reservoir characterization and resource exploration but well log data are limited. For example, the data processing system can be used in fields like petroleum geology. The facies trend model described herein provides a realistic representation of subsurface heterogeneity by providing the reservoir characterization where it was not previously available, enhancing decision-making in resource management and exploration projects (such as drilling).

The advantages can be enabled by one or more of the following embodiments.

In a general aspect, a method for geology-based facies trend modeling for extracting hydrocarbons from a subsurface region includes accessing a three-dimensional (3D) facies model including a set of layers, each layer including boundaries data representing initial facies boundaries for a set of facies represented in that layer; accessing geological constraints data representing facies trends for the set of facies represented in the facies model; for each layer: for each facies type in the layer, determining, for a portion of the layer, a distance from the portion of the layer to a facies boundary for that facies type in the layer; and based on the distance for each facies type and the facies trends represented in the geological constraints data, determining a facies probability value; stacking the layers each including facies probability values for each facies type represented in that layer; based on the facies probability values of the stacked layers, simulating facies trends for each facies type; and generating a 3D facies trend model including the simulated facies trends.

In some implementations, the method includes generating the 3D facies model by: receiving, from a plurality of wells of a reservoir, well log data measured by sensors in each of the wells of the plurality of wells, the well log data representing porosity measurements of the subsurface region at each of the wells of the plurality, wherein at least a subset of the wells are associated with facies data representing facies at the subset of the wells; determining, from the facies data, facies proportions associated with the subset of wells; and based on the updated facies proportions at the plurality of wells, generating the 3D facies trend model for the subsurface region at each of the wells of the plurality.

In some implementations, the subset of wells include cored wells from which facies data are directly measured.

In some implementations, the method includes generating, based on the 3D facies trend model, extended facies data for one or more wells of the plurality of wells that are not in the subset of wells that are associated with facies data.

In some implementations, the extended facies data represent facies that are present at each of the plurality of wells.

In some implementations, the method includes determining, based on the 3D facies trend model, reservoir volumetrics data for the subsurface region; and determining, based on the reservoir volumetrics data, a location in the subsurface region that includes hydrocarbon deposits.

In some implementations, the method includes drilling, at the location in the subsurface region, a well.

In some implementations, the method includes detecting, in the facies data of well log data, vertical trends in facies in the subsurface region; generating vertical proportion curves from the vertical trends in the facies data; and generating, based on the vertical proportion curves, the 3D facies model.

In a general aspect, a system for geology-based facies trend modeling for extracting hydrocarbons from a subsurface region includes at least one processor; and a memory storing instructions that, when executed by the at least one processor, cause the at least one processor to perform operations of the methods described herein.

In a general aspect, one or more non-transitory computer readable media store instructions for geology-based facies trend modeling for extracting hydrocarbons from a subsurface region. The instructions, when executed by at least one processor, configured to cause the at least one processor to perform operations of the methods described herein.

The details of one or more embodiments are set forth in the accompanying drawings and the description below. Other features and advantages will be apparent from the description and drawings, and from the claims.

### BRIEF DESCRIPTION OF THE DRAWINGS

FIG. 1 shows a plot that illustrates an example of facies in an area of a reservoir.

FIG. 2 illustrates a process for building a geological facies trend model

FIG. 3 shows an example of a facies pie-chart map.

FIG. 4 shows an example of a geological grid.

FIG. 5 shows an example of a facies well log upscaling model.

FIG. 6 shows examples of facies proportion maps.

FIG. 7 shows an example visualization of determined vertical proportion curves.

FIG. 8 shows examples of 3D facies trend models.

FIG. 9 shows an example of a facies model.

FIG. 10 shows example facies models.

FIG. 11 shows a flow diagram illustrating a process for a facies modeling.

FIG. 12 shows an illustration of example facies maps.

FIG. 13 shows an illustration of example facies trend maps.

FIG. 14 shows a flow diagram representing a process for performing a distance-based facies probabilities determination.

FIG. 15 shows an illustration of top views of distance models.

FIG. 16 shows an illustration of top views of distance models.

FIG. 17 shows an illustration of maps illustrating the probabilities data from a distance model.

FIG. 18 shows an illustration of facies probabilities data for each of mud-dominated packstone and grainstone.

FIG. 19 shows an illustration of 3D views of the distance-based facies trend models.

FIG. 20 shows an illustration of a facies model.

FIG. 21 shows example slices of the facies model of FIG. 20.

FIG. 22A shows an illustration of a slice of the facies model.

FIG. 22B shows an illustration of facies at the cross section of FIG. 22A.

FIG. 23 shows an illustration of a scatter plot of upscaled wells verses the model for validation of the model.

FIG. 24 shows an example process for generating a facies trend model.

FIG. 25 is a diagram of example hydrocarbon production operations.

FIG. 26 is a diagram of an example computing system.

### DETAILED DESCRIPTION

This specification describes processes and systems for hydrocarbon extraction from a subsurface. Specifically, this specification describes a data processing system configured to perform facies modeling and a control system for controlling well drilling based on the output of the porosity dash assisted facies modeling.

Generally, facies trend models can be generated combining areal two-dimensional (2D) trend data with one-dimensional (1D) vertical trend data. When there are sufficient data, block kriging can be applied for a direct calculation of three-dimensional (3D) trends.

The data processing system is configured to generate a geological-driven facies trend models based on the following described workflow. A trend building process is enhanced to generate geologically sound trend models. Well data are typically available from wells drilled for a best economy return for hydrocarbon extraction, and the data may not necessarily be uniformly distributed to capture, in 2D trend maps and vertical proportion curves, a true depositional trend. Distortions in the model may arise when the geology is complex and/or wells are sparse. The data processing system is configured to overcome these issues to predict the geological evolution history by integrating the regional tectonic evolution history, the regional geology settings, the core data and outcrops, well logs and even production performance. The 1D and 2D trends can be insufficient to enable a data processing system to reproduce the depositional history data that are used as input data for facies evolution history reproduction. Based on these 1D and 2D trends alone, a data processing system cannot predict facies following sequence stratigraphy. Therefore, the 1D and 2D geostatistical facies models do not have the predictive power as geological trend maps.

The data processing system can integrate data from geological theories, such as sequence stratigraphy, to predict facies depositional trends. The 2D trend maps provide a high-level summary of the facies depositional trend, by integrating core data, well logs, tectonic evolution history, seismic, production response, and so on. The enhanced facies trend models generated by the data processing system are called geological-driven, or sequence-stratigraphic driven, facies trend models.

The data processing system described herein is configured to generate facies trend models by manipulating facies trend polygons layer by layer, by lateral shifting trend polygons, increasing or decreasing polygon size, or combining these two solutions together, as subsequently described. As the result, the data processing system manipulates the trend boundary polygons to generate data that reproduces depositional history information. The data processing system can generate a geologically sound facies model with improved predictive power for well production, relative to the 1D/2D trend analysis alone.

The data processing system described herein is configured to generate a facies trend model by converting one-set facies boundary polygons per geological zone or sequence to one-set facies boundary polygons per each geological layer, as subsequently described. The polygons are manipulated based on both well data and geological data. The data processing system can produce the facies trend model without reliance on a processed-based modeling technique, which is often applied to model meandering rivers and deep-water turbidites evolution process. In the processed-based modeling approach, a computing system generates a geological model by mimicking the depositional process. The processed-based modeling approach is applicable only to modeling facies with clear geological objects, such as a meandering river, or a turbidite lobe. The data processing system described herein can model facies trends by mimicking the depositional process, including manipulating the trend polygons data. The data processing system is configured to be applied to a more general case where the deposition/evolution process is known.

The data processing system provides technical benefits including providing an accurate facies trend model when log data are sparse or otherwise insufficient. Geologists typically provide a facies trend map of a specific sequence as a set of polygons that represent the most-likely facies boundaries. Because sequences are related to relative sea-level change/shifting, facies are expected to evolve in a specific trend, such as shifting along slope from deeper locations towards shallower locations when sea level arises, instead of a random deposit. Specifically, based on sequence stratigraphy theory, and the understanding the sea-level evolution history, geologists predict how facies should develop through time. However, rather than provide facies trend maps of every geological layer, geologists provide a facies trend map of a specific sequence as a high-level summary through a period of time. A map typically contains a set of the polygons, representing the most-likely facies boundaries.

The data processing system described herein maps facies boundaries to each geological grid layer based on trend map data, which is constrained by the facies data on a specific grid layer. The facies boundary polygons are converted to facies probabilities based on the distance to each polygon. Since the conversion is done layer by layer, a 3D facies probabilities model is constructed for each facies. The data processing system applies a geostatistical facies modeling algorithm to integrate those facies trend models to build facies models.

The data processing system generates a geologically accurate facies model with prediction power from sequence stratigraphic theory, instead of randomly populated facies. Sequence stratigraphy includes analyzing sedimentary rock sequences to model a depositional history of an area (such as a reservoir) over time. Sequence stratigraphy focuses on analysis of sedimentary successions in terms of repetitive, genetically related units known as sequences. Sequence stratigraphy includes analysis of depositional sequences, transgressive and regressive systems tracts, and unconformities and stratigraphic surfaces. By interpreting these features or elements, the data processing system can reconstruct changing positions of shorelines and environments through time. The data processing system can use the reconstruction to determine facies trends and determine well placement for natural resources like oil and gas, as described previously.

Facies trends depend on the sequence stratigraphy of the region. The dependency is based on integration of eustatic sea level changes, sedimentation rates, and tectonic processes. Specifically, there are several features of an environment or area that the data processing system uses to reconstruct facies trends. The features or elements include the following.

The data processing system is configured to analyze base-level changes for determining facies trends. The base-level changes include fluctuations in eustatic sea level that influence the positioning of sequence boundaries and affect accommodation space and sedimentation patterns. Transgressions and regressions lead to the formation of specific facies in response to changes in water depth and energy conditions.

The data processing system is configured to analyze systems tracts for determining facies trends. Different systems tracts within a sequence represent distinct phases of sedimentation. Highstand systems tracts (HST) can exhibit progradation, creating shallow-water facies; transgressive systems tracts (TST) can result in retrogradation and the development of deeper-water facies; and lowstand systems tracts (LST) are associated with progradation and exposure. Each of these systems tracts can cause unique facies to form in the environment or area.

The data processing system is configured to analyze environmental surface unconformities for determining facies trends. Sequence boundaries and other crosional surfaces affect facies distribution. Erosional surfaces influence preservation or removal of sediments, impacting the development of facies during subsequent deposition.

The data processing system is configured to analyze an environment's accommodation space for determining facies trends. Variations in accommodation space, controlled by subsidence rates, influence the type and distribution of facies. High accommodation space can cause accumulation of finer-grained facies, while low accommodation space can produce coarser-grained facies.

The data processing system is configured to analyze an environment's sediment supply for determining facies trends. The changes in sediment supply, influenced by factors such as tectonic activity, climate, and drainage patterns, affect the composition and characteristics of deposited facies.

The data processing system analyzes the stratigraphic controls or factors for facies development in a region. The data processing system can determine an evolution of facies within a sedimentary sequence and reconstruct the paleoenvironmental conditions that prevailed during different stages of deposition.

Among these sequence stratigraphic controls or factors, sea level changes exert an influence on facies evolution within sedimentary sequences. The eustatic (global) and relative (local) sea level fluctuations shape the depositional environments and the types of sedimentary facies that develop. The sea level changes cause shifts in accommodation space, influencing the development of specific facies during different phases of a sedimentary sequence. The data processing system analyzes these relationships for reconstructing palcoenvironments, interpreting stratigraphy, and predicting reservoir characteristics.

The data processing system determines how sea level changes impact facies evolution as follows. During transgression, as a sea level rises, marine environments encroach landward. Shallow marine and coastal facies, such as beach sands and barrier islands, evolve into deeper marine facies like mudstones and shales. During regression, as the sea level falls, marine environments retreat seaward. Regression leads to the development of terrestrial and shallow marine facies, including fluvial, deltaic, or tidal deposits.

The data processing system determines how sea level changes affect the accommodation space and sedimentation in a region. During highstand conditions, a rate of sea level rise is slowing down. The accommodation space is high and sediment supply is still high. Highstand conditions result in progradation of sedimentary facies, forming deposits like deltaic systems, carbonate platforms, or shelf sands. During lowstand conditions, the accommodation space decreases due to sea level fall. Facies associated with lowstand conditions include incised valleys, fluvial deposits, and erosional surfaces.

The data processing system determines how sea level changes affect the systems tracts in a region. For a transgressive systems tract (TST), rising sea level at high rates exceeding that of deposition cause development of offshore and deeper marine facies. Transgressions may drown proceeding basins and form new basins landward and deep marine deposits would overlay previous shallow marine deposits. For a highstand systems tract (HST), a decreasing rate of sea level rise allows for progradation of sedimentary facies such as deltaic deposits, shoreface sands, and carbonate platforms. For a lowstand systems tract (LST), a falling sea level exposes previously submerged areas, leading to the development of fluvial, deltaic, or incised valley-fill facies.

The data processing system determines how sea level changes affect the sequence boundaries in a region. Sequence boundaries can be conformable or unconformable based on whether there is a significant time gap between when rocks under the boundary and rocks over it have formed. Sea level changes can manifest as sequence boundaries. Unconformities associated with these boundaries are a result of crosional surfaces or periods of non-deposition, affecting the preservation and distribution of facies. When there is an unconformity landward, there will almost always be a time-equivalent conformable surface basin-ward. Correlative conformities are sequence boundaries which also control facies distributions vertically and laterally.

The functionality of the data processing system is described in the context of an example reservoir that is now described. While the example given is illustrative of data processing for generating facies trend models, the example is not exhaustive. Rather, the example provided is intended to show how facies trends are modeled using example data. The example reservoir includes 54 wells in a 25,000 meter (m) by 33,100 m area.

Based on predominant rock types, four facies are identified within marine settings, including wackestone, mud-dominated packstone, grain-dominated packstone, and grainstone, which are classified within the limestone spectrum, reflecting varying degrees of grain content and texture. Wackestone includes a mud matrix with grains. Packstone includes a relatively higher proportion of grains than wackestone. Grainstone can be predominantly composed of grains, indicating different sedimentary environments and processes. Wackestone tends to form in areas with relatively low energy, such as deeper parts of the ocean or quiet lagoons. In these environments, fine particles of mud accumulate along with biogenic components like shells and organic debris, creating a matrix. Packstone environments typically experience slightly higher energy conditions compared to wackestone settings. Packstone environments can be found in shallower marine areas or areas with moderate water flow. The increased energy in packstone environments allows for a greater proportion of skeletal fragments and grains to be present, contributing to a more grain-supported texture. Grainstone environments are typically associated with higher energy settings, often include shallow, well-lit areas such as shoals, reef crests, or high-energy shorelines. The relatively increased energy in grainstone environments, relative to wackestone environments, allows for better sorting and transportation of sediment particles.

Reservoir quality is inversely correlated with depositional mud content given diagenetically unaltered texture. The mud-rich facies such as wackestone and mud-dominated packstone are deposited in lower hydrodynamic energy whereas grain-rich facies are deposited in higher hydrodynamic energy. The data processing system, by modeling facies boundaries and how they change, is further configured to perform reservoir properties modeling.

Changes of relative sea levels results in a lateral shift of such hydrodynamic energy regimes. The shift causes a shift in deposited facies belt boundaries. Other changes can occur with certain facies boundaries, such as coral reefs and grainstone shoals. These facies boundaries can expand or shrink before shifting. For example, if a relative sea level drops, the facies would shift towards the deeper parts of the slope (and vice-versa).

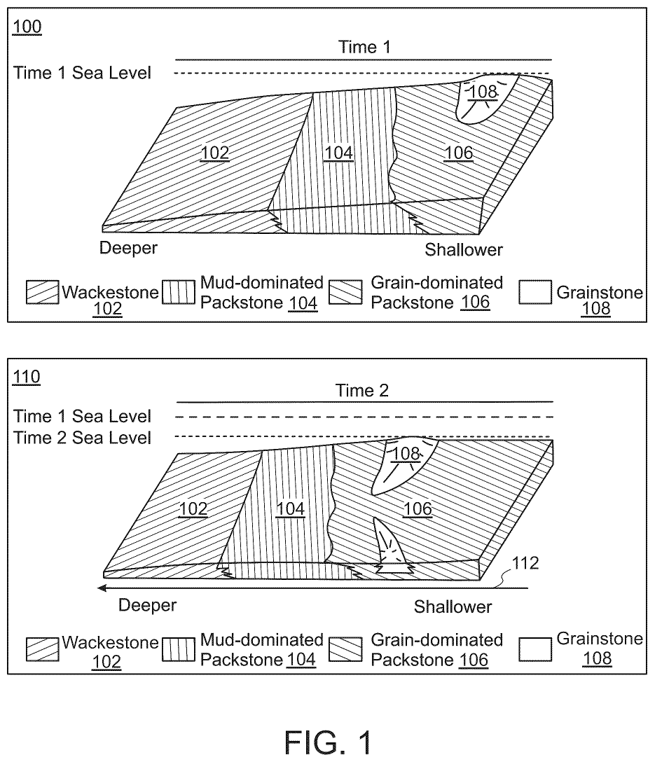

FIG. 1 shows a plot 100 that illustrates an example of facies 102, 104, 106, and 108 set on a slope where the shallow facies are grainstone shoals and grain-dominated packstone belt which lack mud due to a higher hydrodynamic energy, and mud-dominated packstone and wackestone belts are deposited in deeper parts of the slope with lower hydrodynamic energy resulting in higher mud content. As sea level drops, shown in plot 110, a facies boundary of grainstone 108 expands, and all facies belts move laterally (along arrow 112) towards the deeper part of the slope in response to sea level drop.

The data processing system is configured to build geological facies trend models for various environments, such as environments that comport with plots 100 and 110 of FIG. 1. Constructing a geological facies trend model involves developing a simplified representation of the spatial distribution of different sedimentary facies, such as facies 102, 104, 106, and 108, within a geological system.

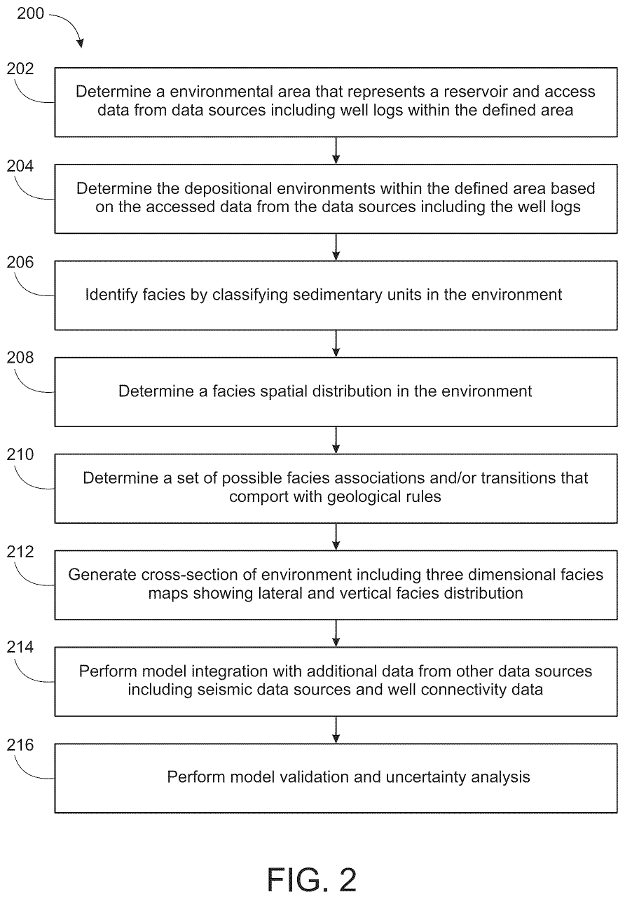

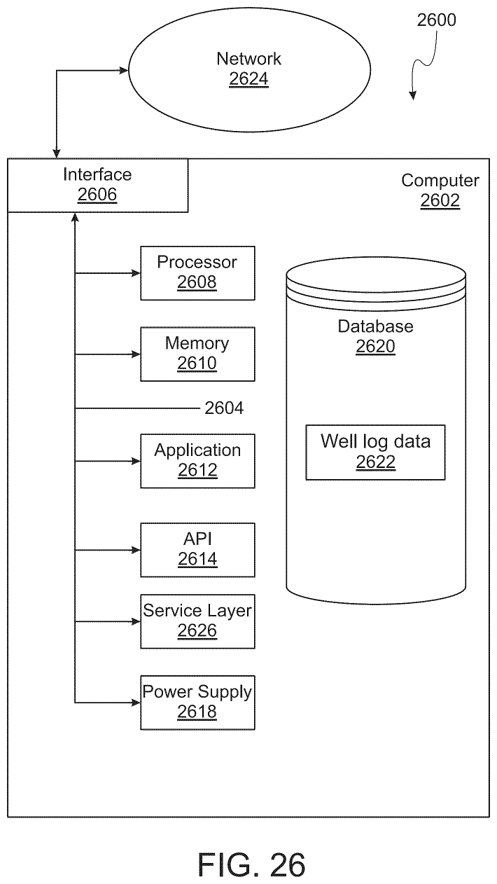

FIG. 2 illustrates a process 200 for building a geological facies trend model. The process 200 can be performed by a data processing system, such the data processing systems described herein (and in relation to FIG. 26).

The process 200 includes defining or determining (202) an area of an environment that represents a reservoir. The area can include a set of data sources that provide data about the subsurface in the region. The data processing system can identify a geological area of interest, considering the boundaries of the area and relevant features of the area. The defined or determined area includes a set of data sources that describe the surface and subsurface in the area. For example, the data sources can include well logs associated with wells drilled in the area. The environment can be slightly larger (e.g., 1-5%, etc.) than the reservoir boundary so that the area includes some control wells from nearby fields. The data processing system can process data from the control wells can be to capture a regional depositional trend outside of the reservoir and use this trend for determining specific trends within the reservoir. The data processing system is configured to access geological data from the data sources, including core samples, well logs, seismic data, and outcrop observations. In some implementations, the data processing system access tectonically inverted topography maps or models, which are processed for generating an inference of the depositional environment for the area.

The data processing system is configured to determine (204) the depositional environments within the defined area based on the data from the well logs (or other data sources). The depositional environments can include, for example, fluvial, marine or deltaic depositional environments. The data processing system can determine the classification of the depositional environments based on, for example, sedimentary structures, fossils, and other indicators. The geological settings can be clear based on a regional study, and the conceptual facies model, such as the facies models 100, 110 of FIG. 1, when data from such a study is available for environmental interpretation.

The data processing system is configured to identify (206) facies within the environment, by classifying sedimentary units in the environment. The data processing system is configured to classify the sedimentary units into distinct facies based on lithology, texture, and other sedimentary characteristics such as roots or bioturbation, which are specific environmental indicators. In some implementations, because cored wells are limited due to the cost in the oil and gas industry, facies are typically interpreted from well logs. Creating well log facies based on core data involves integrating information from both well logs and core samples to characterize the subsurface sedimentary formation.

The data processing system is configured to determine (208) a facies spatial distribution in the environment. The data processing system analyzes the spatial distribution of facies within the study area, considering factors like water depth, proximity to shorelines, and sediment transport dynamics. The distribution refers to the relative sizes and arrangement of the facies within the environment, such as which facies border one another and how the borders are each shaped. The data processing system is configured to determine which facies distributions are possible in the area based on the available geological data previously described.

The data processing system determines (210) a set of possible facies associations within the environment. The data processing system identifies patterns of facies associations or transitions, based on how different facies can relate to each other in space. The facies associations comport with geological rules and constraints. For example, the geological rules permit certain facies to border one another or have specific sizes relative to one another. The most common rules govern a spatial relationship of facies. For example, facies formed in deep water are not adjacent to facies formed in very shallow water unless there is a facies formed in intermediate water depth in-between. In another example, deltaic facies associations are not adjacent to estuarine facies association but can overlay one another. Other such rules are possible.

The data processing system generates (212) one or more cross-sections and/or maps of the environment. The cross-sections or maps can represent the area in 3D, including vertical and lateral distributions of facies within the geological system of the area. In some implementations, facies pie chart maps can visually represent the distribution of different sedimentary facies for every well within a geological formation or sequence. Each pie chart represents the facies composition in that specific location. The data processing system uses a facies pie chart map to represent a spatial distribution and relationships between different facies within the geological setting of the area.

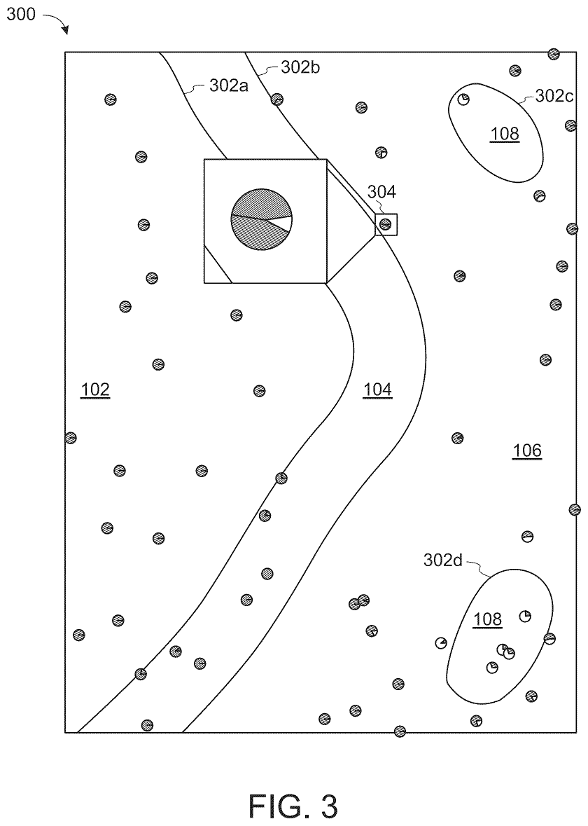

FIG. 3 shows an example of a facies pie-chart map 300. The map 300 includes borders 302a-d of facies within an example area corresponding to plot 110 of FIG. 1. Each pie chart (such as example pie chart 304) provides a distribution of facies classification probabilities for that location within the environment. In some implementations, each pic chart (such as example pie chart 304) corresponds to a well or data source that provides data about the environment at that specific location. The facies pie chart map 300 represents a distribution of the sedimentary facies (e.g., facies 102, 104, 106, and 108) and their relative proportions in a given area (such as the area of plot 110).

Returning to FIG. 2, the data processing system is configured to perform (214) a model integration. The model integration includes information from various data sources, such as seismic-inverted attributes, production data (especially well connectivity data), and so forth. The data processing system can refine and validate the facies model based on these additional data sources. For example, if seismic data are available, the data processing system can determine whether the predicted facies for a location in the environment comports with the expected facies based on the seismic data.

The data processing system is configured to perform (216) model validation and perform an uncertainty analysis of the predictions to generate the final predictions for the area. The data processing system provides a realistic representation of the reliability of the generated model by providing the uncertainty associated with each prediction. Additionally, the conceptual facies model is documented with the parameters, assumptions, and interpretations made during the modeling process. As previously stated, the data processing system validates the model against additional data (such as seismic data or well connectivity data). In some implementations, the data processing system validates the model based on comparisons with other similar geological settings.

The data processing system builds the facies model using an iterative process that involves refining interpretations based on additional data from the environment. The data processing system generates a representation of the geological trends of the environment that enable predictions of the facies distribution for subsurface reservoirs or other geological features. The data processing system can predict changes for both the lateral and vertical facies.

An example of constructing a geostatistical facies trend model by the data processing system is now descried, based on the process 200 described in relation to FIG. 2. The data processing system performs the geological reservoir modeling by integrating geological and engineering data to create a realistic representation of subsurface reservoirs, as previously described. The data processing system, using the geostatistical facies trend model, can generate predictions of reservoir behavior for optimizing resource recovery, such as by guiding well placement.

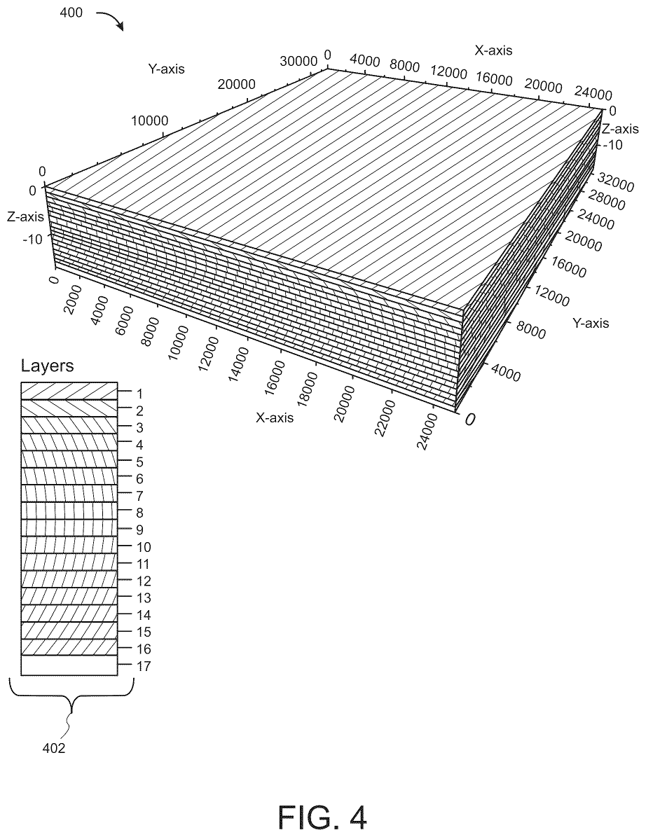

FIG. 4 shows an example of a geological grid 400. The data processing system builds the geological grid 400 as an unstructured grid to demonstrate how sequence stratigraphic knowledge is integrated into the facies trend model. In the example grid 400, both top and base horizons are flat without any faults. The example geological grid includes 250 columns, 331 rows and 17 layers (noted as layers 402) with grid resolution 100 meters by 100 meters by 1 foot. The layers are numbered from the top of the grid to the bottom of the grid such that the topmost layer is layer 1 and the bottom of the grid is layer 17.

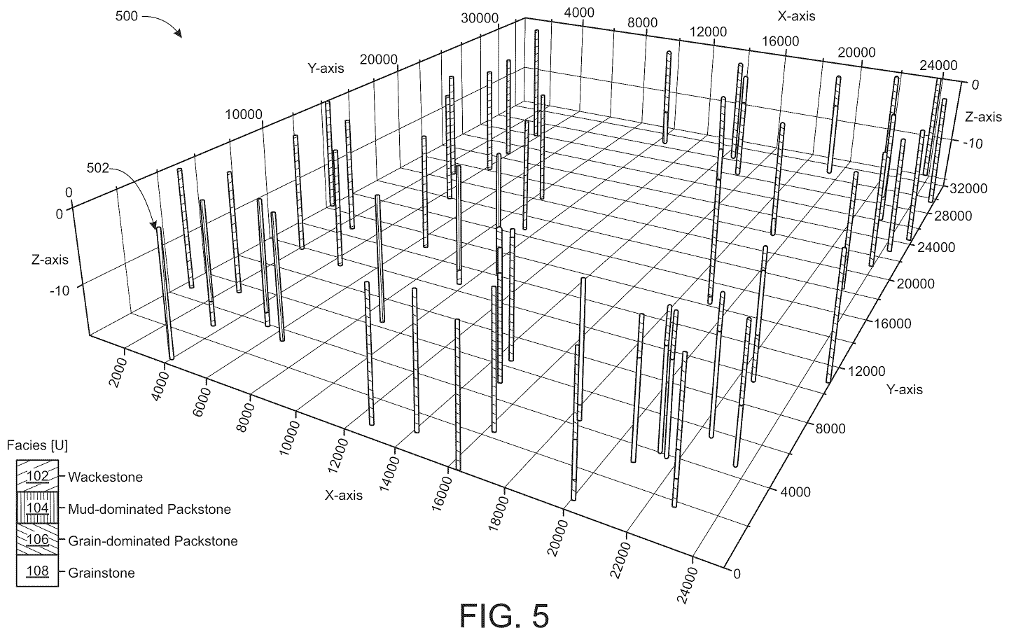

FIG. 5 shows an example of a facies well log upscaling model 500 performed using the grid 400 of FIG. 4 and the facies model 300, described in relation to process 200 of FIG. 2 and plot 110 of FIG. 1. The data processing system performs facies log upscaling for building the geostatistical facies trend model. Well log upscaling, in the context of reservoir modeling, includes a process of aggregating or grouping well log data to create larger blocks or cells within a reservoir model, such as the model of plot 110 described in relation to FIG. 1. Each of the facies 102, 104, 106, and 108 are represented. The data processing system performs the aggregation to simplify and manage the computational complexity of reservoir modeling while preserving the essential geological and petrophysical heterogeneity.

The data processing system builds an initial facies trend model that is a basis for forming the geostatistical facies trend model. The initial facies trends model is generated by performing the following process. The data processing system determines well facies proportions for specified intervals, such as for each geological grid zone. The data processing system generates facies proportion maps including contours used for calculating 2D trends. The data processing system generates facies proportion curves (VPC) used for calculating vertical trends, which are 1D trends. The data processing system generates 3D trend models by combining the 2D trend maps with the 1D VPC.

The data processing system determines well facies proportions for given intervals. The well facies proportions refer to the proportion or percentage of each facies within specific intervals or across the entire reservoir (as described in relation to map 300 of FIG. 3). The data processing system uses the proportions of these facies within a well for reservoir characterization because they represent the heterogeneity of the subsurface formation. The data processing system determines a thickness of each facies relative to the total thickness of the analyzed interval. The data processing system can use the original well logs (as described in process 200) or on the upscaled well logs data 500. The well facies proportions pie chart map 300 is generated based on the original well logs data.

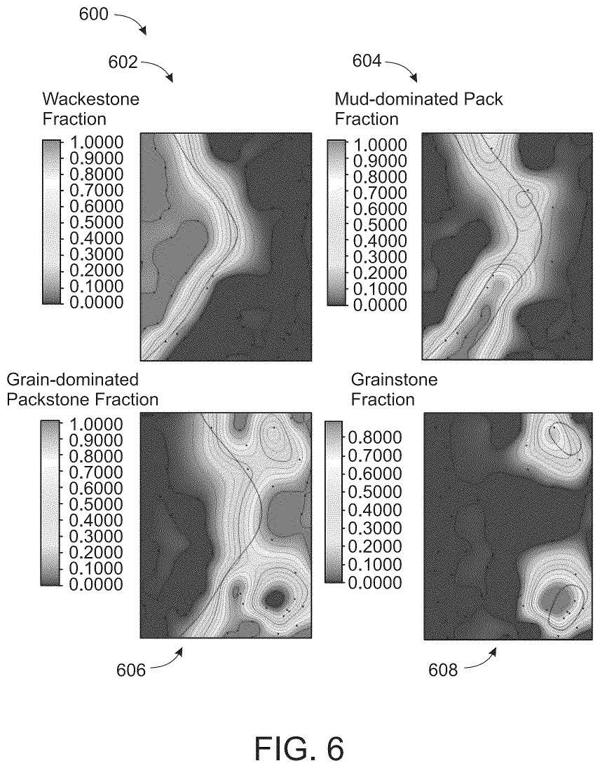

FIG. 6 shows examples of facies proportion maps 600 generated by the data processing system. Facies proportion mapping involves generating data that describes a spatial distribution of different geological facies and their proportions within a reservoir or geological formation. The mapping describes a heterogeneity of the subsurface. The data processing system can generate recommendations for resource exploration and reservoir management based on the mapping data. The data processing system applies spatial interpolation techniques, such as kriging or inverse distance weighting, to estimate facies proportions in unsampled locations. The interpolation captures large-scale variations and trends that may exist in the geological data. The data processing system generates maps 600 using convergent interpolation. Map 602 represents a Wackestone fraction distribution, corresponding to facies 102. Map 604 represents a mud-dominated packstone fraction distribution, corresponding to facies 104. Map 606 represents a grain-dominated packstone fraction distribution, corresponding to facies 106. Map 608 represents a grainstone fraction distribution, corresponding to facies 108.

Generally, even with good well control data, the facies trend shapes of maps 600 do not necessarily follow facies trend lines in some areas. For example, some wells are not well connected when well spacing exceeds a threshold spacing. The contoured facies trend maps 600 are based on the well configuration. Well locations are selected for drilling in good reservoir quality bodies and above oil-water-contact (OWC). Generating a representative facies trend map for oil and gas exploration uses a geological understanding based on maps 600.

Vertical facies proportion curves (VPCs) depict the changing proportions of different geological facies along the vertical depth of a grid. The data processing system uses VPCs for reservoir characterization to identify reservoir zones, stratigraphic variations, and other geological features. VPCs provide a concise and visual representation of facies changes along the vertical axis. VPCs comport with the vertical facies trends if defined by sequence stratigraphy. The data processing system can use VPCs for quality control tool for sequence picking.

The data processing system determines VPCs as described. The proportion or percentage of each facies is calculated layer by layer based on the upscaled well logs. Each curve represents the changing proportions of a specific facies along the vertical depth of the grid.

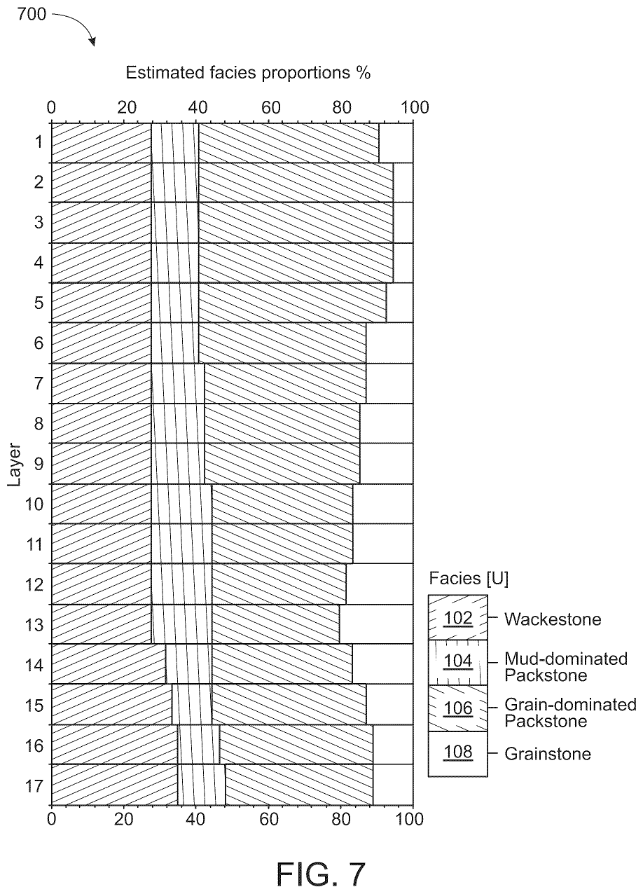

FIG. 7 shows an example visualization of determined VPCs 700 for the reservoir or area described in relation to FIGS. 1-6. The layers 402 (described in relation to FIG. 4) are shown with a facies proportion percentage for each layer. Based on the number of wells available for providing data and the pattern of these wells, the VPCs can be an accurate approximation of the vertical facies trend. In some implementations, the facies percentages from upscaled well logs might not represent the true of area of interest (AOI), depending on the complexity of geology, number of wells and well pattern.

The data processing system generates a 3D facies trend model based on a combination of geological rules, well data analysis, and geostatistical analysis. The data processing system generates facies trend data based on the proportion maps 600 and VPCs as shown in FIG. 7. The data processing system combines these data into a full 3D trend model.

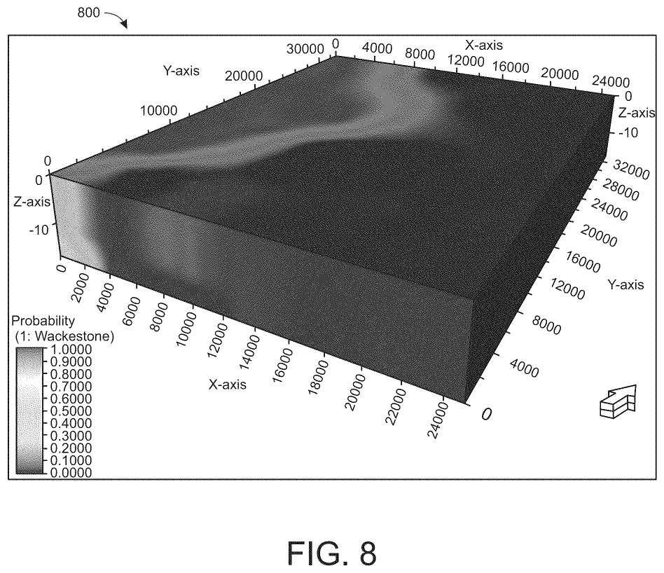

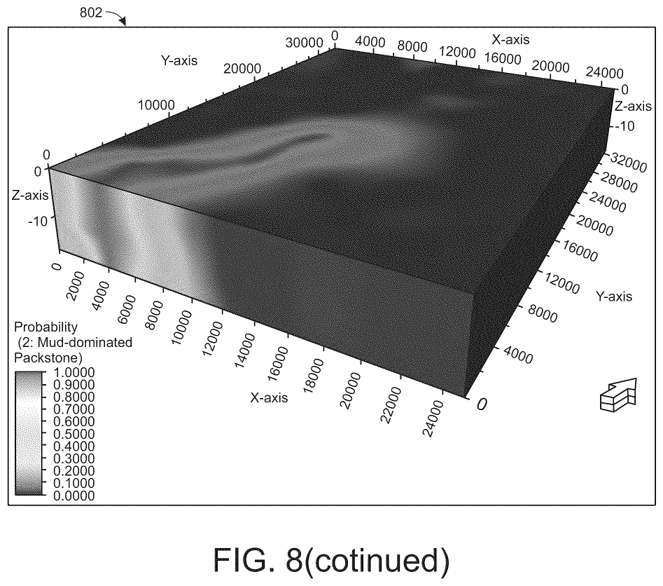

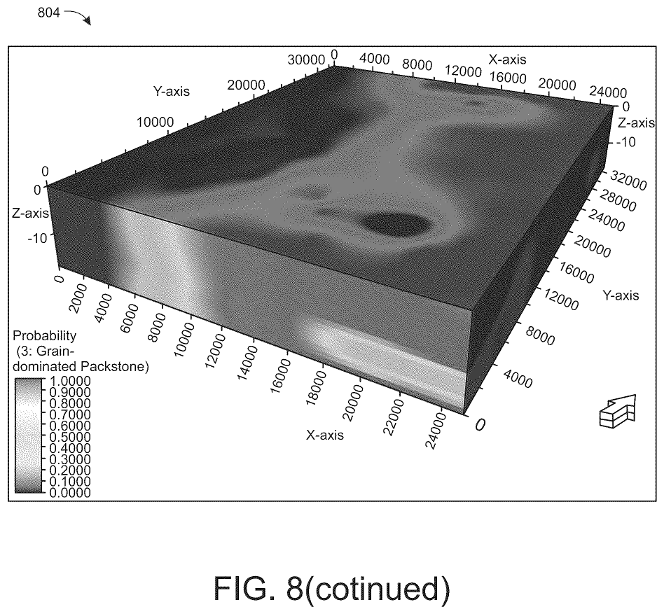

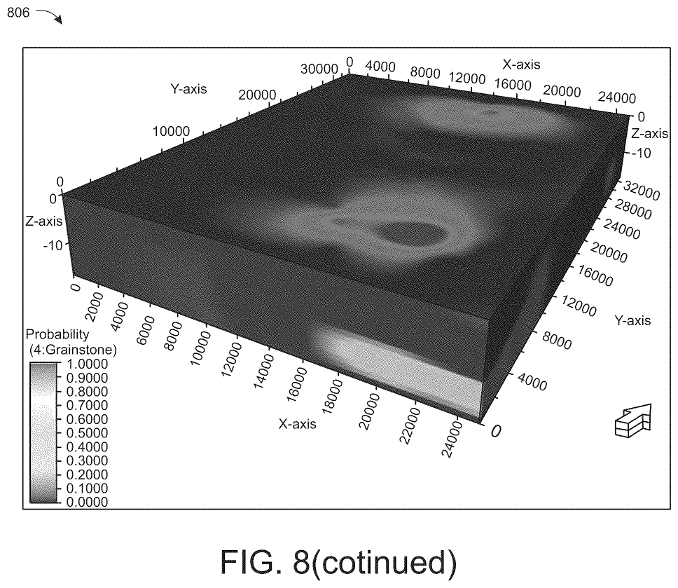

FIG. 8 shows 3D facies trend models 800, 802, 804, and 806. The data processing system generates the 3D trend models 800, 802, 804, 806 by combining the 2D trend maps 600 the 1D VPCs trend data 700. The trend modeling reproduces the observed geological trend, which is not fully captured by well data because wells are preferentially drilled in sandy areas and above fluid contact in the oil and gas industry. The trend model is used for areas without enough well coverage. Without the trend model, those areas are randomly simulated, and the resulting model might not make geological sense. Geological facies trend maps can be generated by a geologist based on a conceptual model, regional study, and local well data, and those trend maps are often plotted for each geological formation or each sequence stratigraphic sequence. Those facies trend maps can be used in geostatistical facies modeling to guide 2D facies distribution. When wells have good regional coverage, the vertical proportions curves (VPC) could be calculated and used to guide vertical facies distribution. If both facies trend maps and VPC are available, they could be combined to generate 3D trend model therefore both lateral and vertical facies distributions could be guided, and there are many algorithms on how to combine the trend maps and VPC. Sometimes, seismic attributes could be derived from high-resolution seismic volume, such as seismic inverted GR cube, and it can be used as 3D trend directly in facies modeling. Many geostatistical algorithms are proposed to integrate trend data, including VPC (1D), trend maps (2D) and trend models (3D).

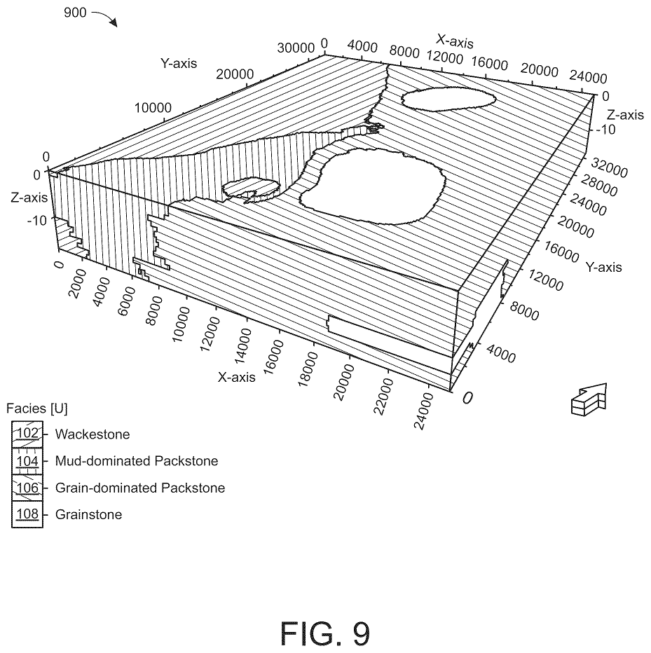

FIG. 9 shows a facies model 900. The data processing system can use the facies trend models to build facies models using one or more geostatistical facies modeling algorithms that have the ability to integrate 3D trend models. In some implementations, the data processing system can use a sequential indicator simulation (SIS). In some implementations, the data processing system can use a truncated gaussian simulation (TGS). Other such examples are possible. The data processing system applies a TGS to build the 3D facies model 900. Facies 102, 104, 106, 108 of some layers are selected to show the vertical facies variations of above the facies model 900. The well control is good for the model 900. Vertical facies variation is very random, instead of showing continuous change, which is common for conventional geostatistical modeling algorithms. In this example, facies do not follow the geological interpretation closely, especially in the middle of the AOI, where wells are sparse.

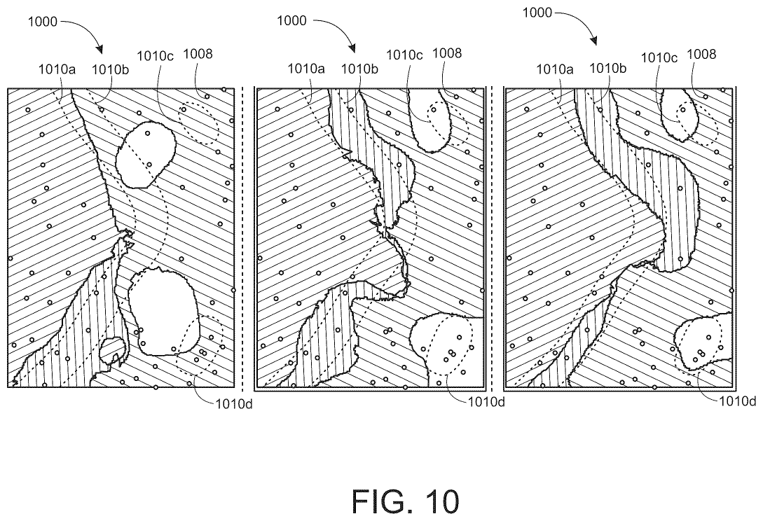

FIG. 10 shows facies models 1000, 1002, and 1004. Each model 1000, 1002, 1004 shows facies of a respective layer. Facies of some layers to show the vertical facies variation. Facies model 1000 shows a top layer (e.g., layer 1). Facies model 1002 shows a middle layer (layer 14). Facies model 1004 shows a bottom layer (e.g., layer 17). Well locations are shown as dots (e.g., dot 1010). The black dash lines (e.g., lines 1010a-c) represent facies boundaries interpreted by the data processing system.

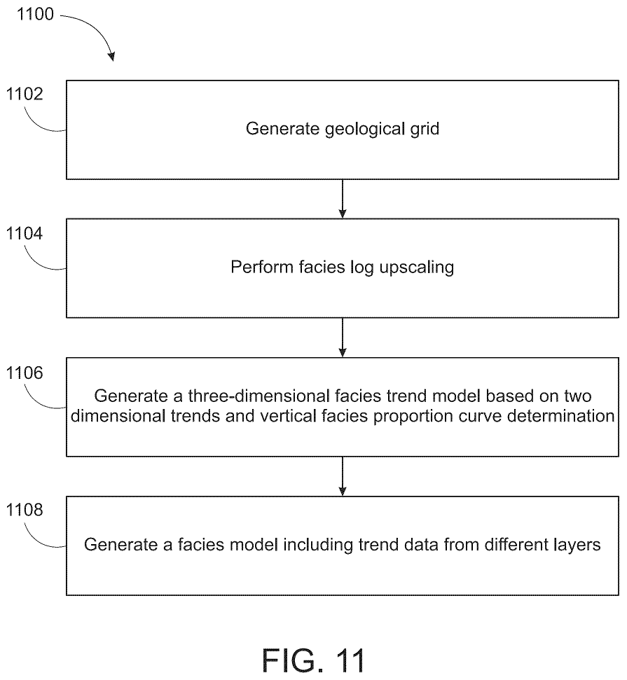

FIG. 11 shows a process 1100 for a facies modeling workflow with trends. The process 1100 includes generating (1102) a geological grid. The geological grid is described in relation to FIG. 4. The process 1100 includes performing (1104) facies log upscaling. The facies log upscaling is described in relation to FIG. 5. The process 1106 includes generating (1106) a 3D facies trend model based on the 2D trends data from the upscaled well logs and the 1D VPC curves, as described in relation to FIGS. 5-7. The process 1100 includes generating (1108) a facies trend model including trend data from different layers. Examples of the 3D facies models are shown in FIG. 8.

The data processing system is configured to generate a geological-driven facies trend models based on the following described workflow. The trend building process 1100 described previously is enhanced to generate geologically sound trend models. Well data are typically available from wells drilled for a best economy return for hydrocarbon extraction, and the data may not necessarily be uniformly distributed to capture, in 2D trend maps and vertical proportion curves, a true depositional trend. Distortions in the model may arise when the geology is complex and/or wells are sparse. The data processing system is configured to overcome these issues to predict the geological evolution history by integrating the regional tectonic evolution history, the regional geology settings, the core data and outcrops, well logs and even production performance. The data processing system can integrate data from geological theories, such as sequence stratigraphy, to predict facies depositional trends. The 2D trend maps provide a high-level summary of the facies depositional trend, by integrating core data, well logs, tectonic evolution history, seismic, production response, and so on. The enhanced facies trend models generated by the data processing system are called geological-driven, or sequence-stratigraphic driven, facies trend models.

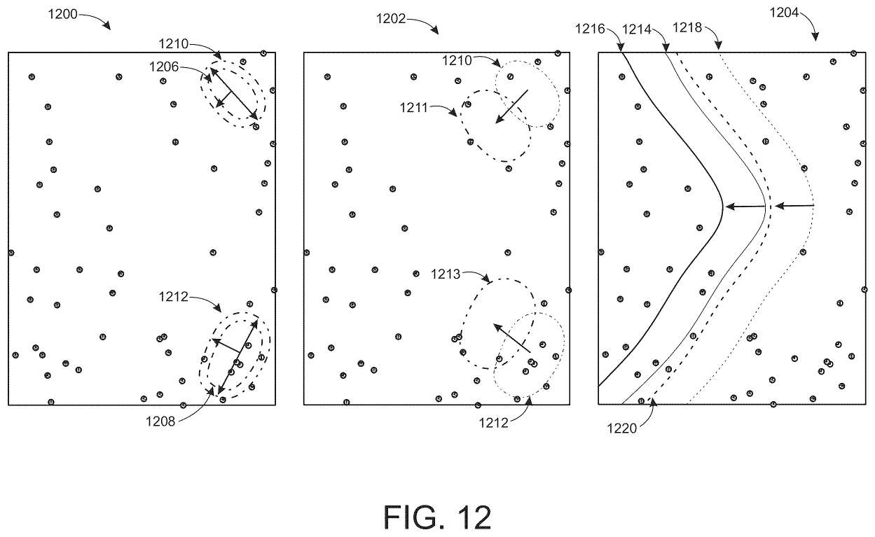

The data processing system is configured to predict facies evolution based on sequence stratigraphic data. FIG. 12 shows facies maps 1200, 1202, and 1204 of the reservoir area 100, 110 described in relation to FIGS. 1-11. Grainstone 108 is associated with high-energy reef crests. In map 1200, at time 1, the grainstone areas 1206 and 1208 grow in the same locations. Grainstone area 1206 grows to area 1210. Grainstone area 1208 grows to area 1212. In map 1202, at time 2, after the grainstone areas 1206, 1208 grow to some extent, they each start to grow laterally because of sea level changes, which causes a changed accommodation space. At time 2, grainstone area 1210 shifts and grows to area 1211. At time 2, grainstone area 1212 shifts and grows to area 1213.

The other facies of the environment 100, including wackestone 102, mud-dominated packstone 104, and grain-dominated packstone 106, form in order in a slope environment. These facies 102, 104, 106 grow laterally responding to sea level changes. As shown in map 1204, the wackestone 102 grows from location 1214 to 1216. As shown in map 1204, the grain-dominated packstone 106 grows from location 1218 to 1220, each shifting to the left.

For sequence-stratigraphic-driven facies trend mapping, the data processing system accesses the facies trend model described previously. The facies trend model can include a set of polygons representing the various facies boundaries. The data processing system can generate facies trend maps for each geological grid layer representing the facies evolution process, as shown in maps 1200, 1202, 1204.

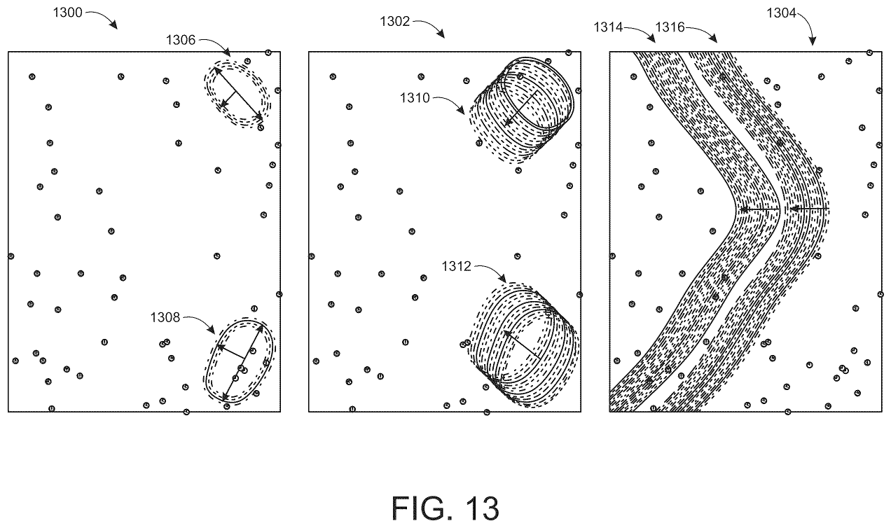

FIG. 13 shows facies trend maps 1300, 1302, 1304. The expected facies trends through the layers are shown in groups 1306, 1308, 1310, 1312, 1314, and 1316. Polygons are used to represent expected facies boundaries layer by layer. When the facies evolution history is known, the data processing system reproduces the facies evolution history by manipulating the facies boundary polygons layer-by-layer based on the expected facies evolution history based on multidisciplinary analysis and the upscaled facies log data for each geological layer as hard data and constraints. The groups 1306, 1308, 1310, 1312, 1314, and 1316 of lines showing the layer-by-layer facies evolution, such as over the 17 layers described previously.

The data processing system determines facies probabilities based on boundary polygons. The geostatistical facies probabilities determination includes assessing the likelihood of different facies within a geological formation. The data processing system performs geostatistical modeling for the determination. For the geostatistical modeling, the data processing system can use spatial and statistical methods to estimate the distribution of facies in a given area. To enhance a purely geostatistical solution for reproducing geological trends, the data processing system uses a distance-based facies probabilities determination process.

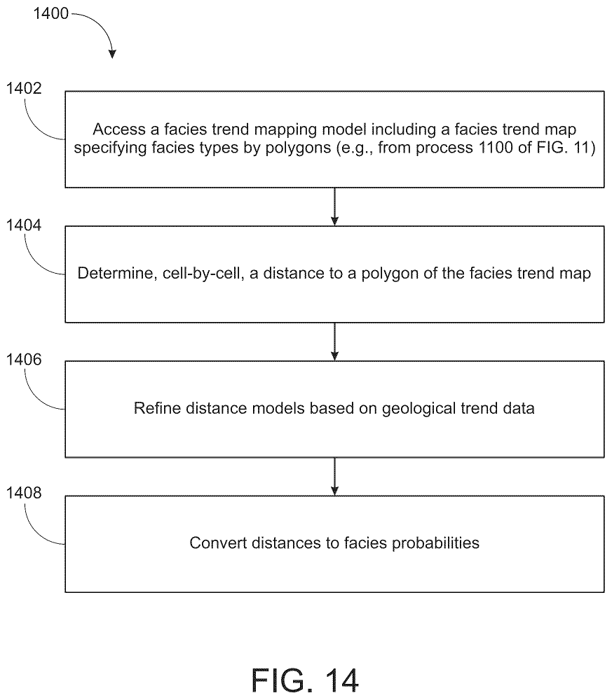

FIG. 14 shows a process 1400 for performing a distance-based facies probabilities determination by the data processing system. The data processing system is configured to access (1402) a facies trend mapping model, such as the model generated by process 1100. The trend map specifies facies types by polygons. The data processing system is configured to convert facies boundary polygons to facies probabilities. The data processing system, for every geological grid layer, determines (1404) a distance to a specific polygon. The data processing system can calculate the distances cell-by-cell. A distance is a minimum or closest distance from a cell center to the polygon.

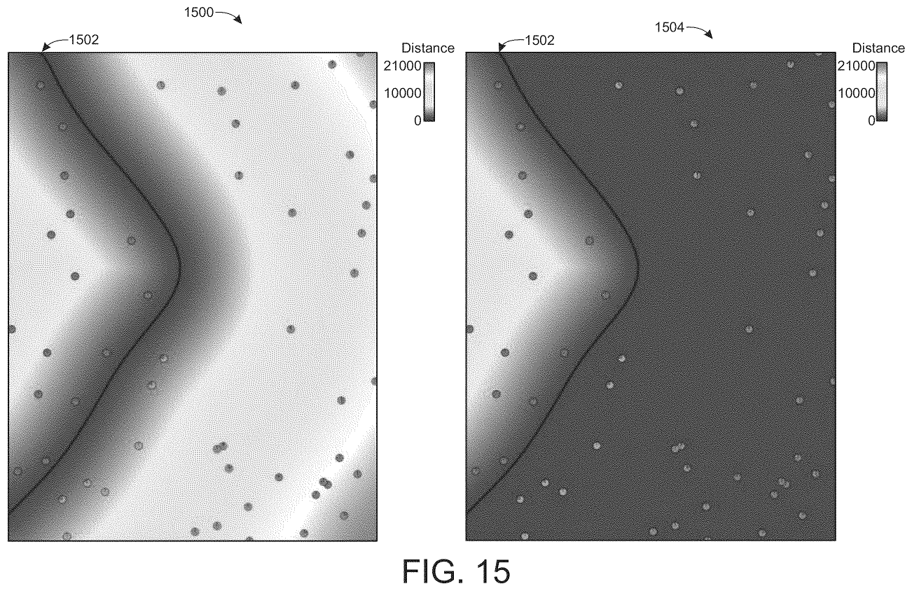

FIG. 15 shows a top view 1500 of a layer 1 of area 100, 110 including a distance model representing the distance to a wackestone boundary polygon 1502, as shown by a gradient. Based on the understanding of the geological trend, a distance for one side is clipped to a specific value, as shown in view 1504 of layer 1. The map 1504 represent a transition zone around the boundary polygon 1502. For example, wackestone tends to deposit in low energy environment, which is to the west side of the example area 100, 110. Wackestone is deeper along the slope. The probabilities for wackestone decrease towards the east when water is getting shallower.

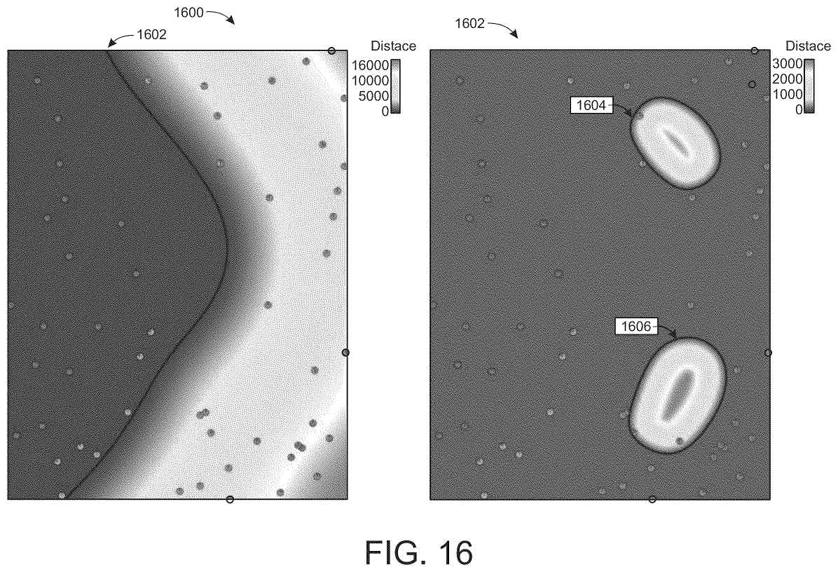

Packstone typically deposits in slightly higher energy conditions compared to wackestone settings. Therefore, grain-dominated packstone tends to increase towards the east side of the grid. FIG. 16 shows a top view 1600 of a layer 1 of area 100, 110 including a distance model representing the distance to a packstone boundary polygon 1602, as shown by a gradient. FIG. 16 shows a top view 1604 of a layer 1 of area 100, 110 including a distance model representing the distance to a grainstone boundary polygon 1604, 1606, as shown by a gradient. Grainstone environments are associated with high energy reef crests, so the distance is out of the grainstone polygons.

Returning to FIG. 14, when the distance model is ready, the data processing system converts the distance to facies probabilities. The data processing system can calculate the probabilities as follows. The data processing system refines (1406) the distance models based on the geological trend data.

Once the distance models are refined, the data processing system converts (1408) the distances to probabilities for each facies type. Each facies type can be associated with a different conversion model. For example, for a left of the wackestone polygon 1502, the data processing system can determine the probability by equation (1):

$${p}_{wackestone} = \frac{distance}{maximum} \times Scaling Factor + additional \qquad ( 1 )$$

The data processing system adds an additional item to ensure that probabilities at polygon locations are not zero, but 0.5 in this case. A scaling factor of 10 is applied, which means that at 0.05*maximum distance, the probabilities reach 1.0 already. The maximum distance is about 1050 meters, or 10 grid cells. To the right side, the facies probability is calculated with equation (2):

$${p}_{wackestone} = \frac{transition - distance}{transition} \times additional \qquad ( 2 )$$

The transition is the transition zone range to another side. The range of 100 meters is used in this example, but other ranges are possible. The above solution can create smooth transition across the boundary polygons, but the transition zone ranges to each side are controlled separately.

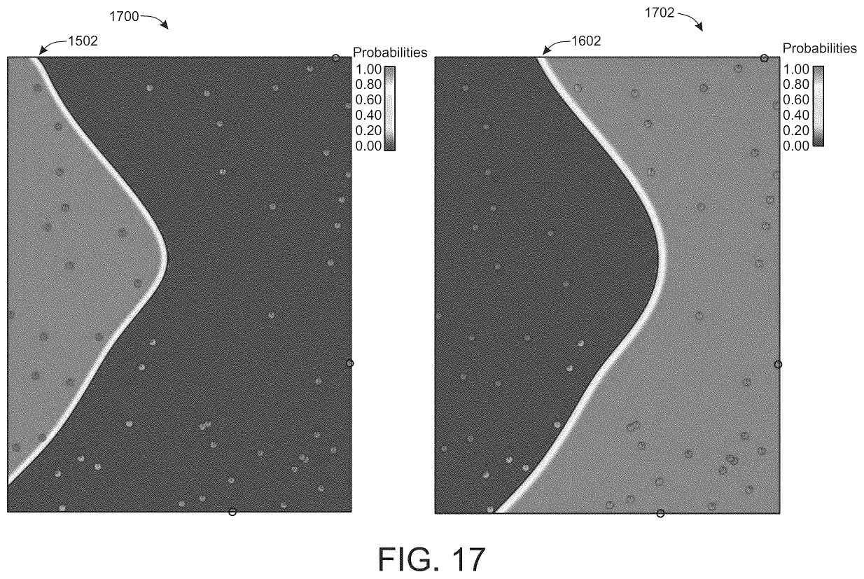

FIG. 17 shows a map 1700 showing the probabilities data determined based on for the wackestone boundary 1502. The map 1702 shows the grain-dominated packstone probabilities data, which can be calculated in a similar manner as the wackestone probabilities data.

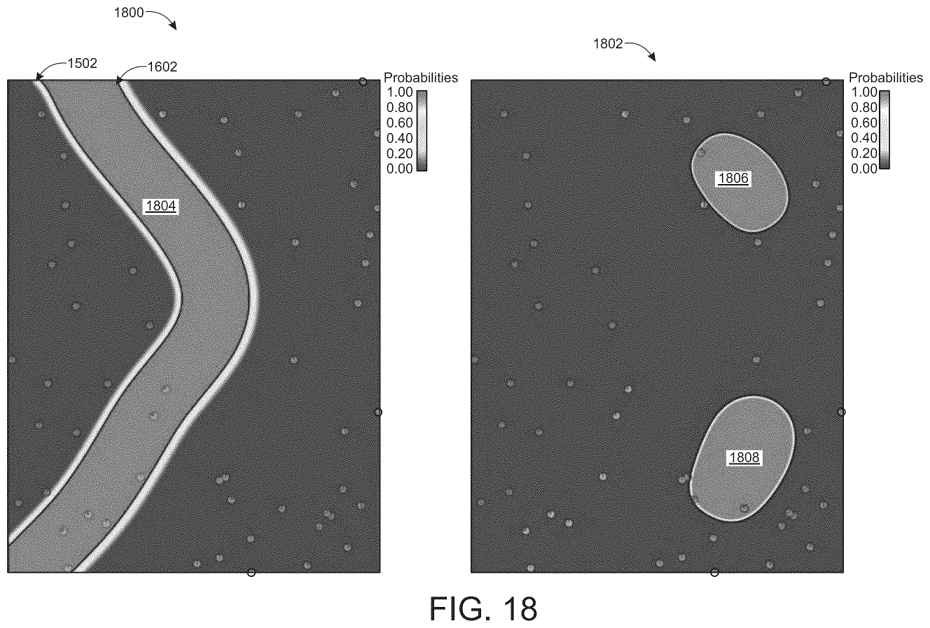

FIG. 18 shows facies probabilities data for each of mud-dominated packstone and grainstone. The mud-dominated packstone probabilities are in map 1800, and the grainstone probabilities are shown in map 1802. The data processing system determines the values for the mud-dominated packstone probabilities based on equation (3)

$${p}_{mud - dominated packstone} = 1. - {p}_{wackestone} - {p}_{grain - dominated packstone} \qquad ( 3 )$$

The mud-dominated packstone probability model 1800 shows a band of high probabilities 1804 within the wackestone and packstone boundaries previously described. The grainstone probability is higher inside the polygons 1806, 1808, as shown in the probability model 1802. Rather than universal solutions for the distance-based facies probabilities model building, the data processing system checks the facies model (e.g., model 900) based on the facies probabilities models 1700, 1702, 1800, 1802 to validate the algorithms used.

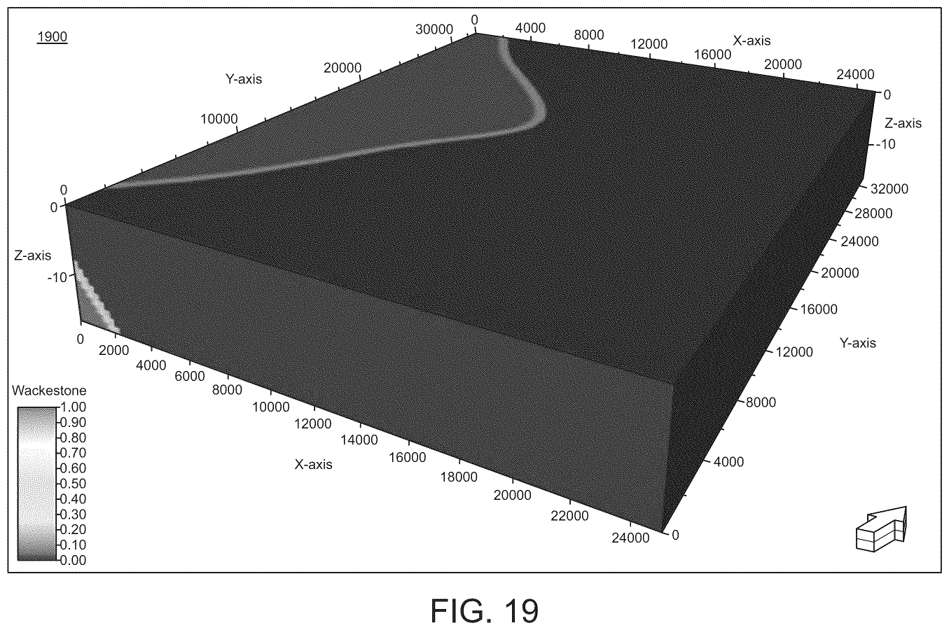

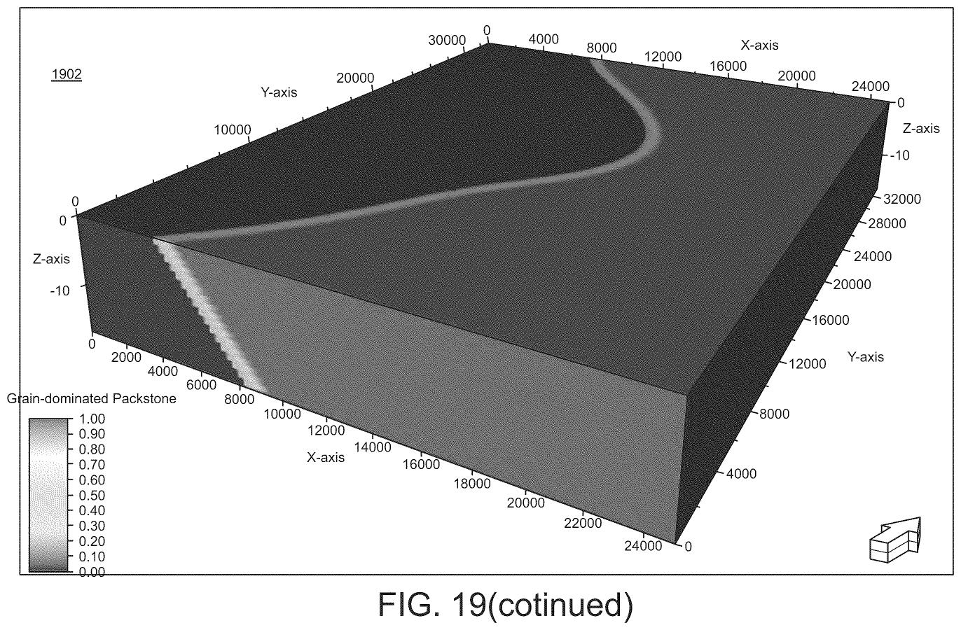

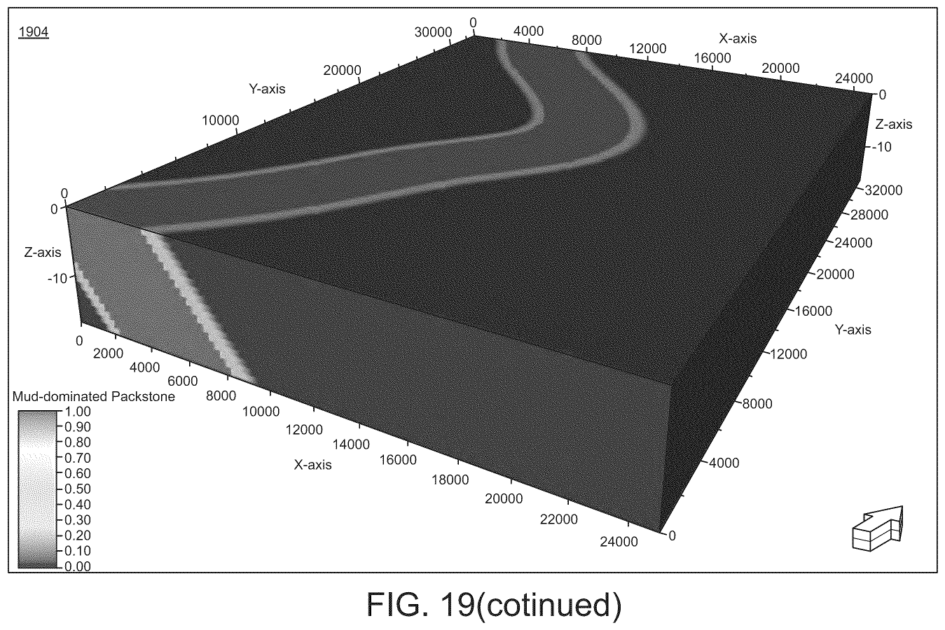

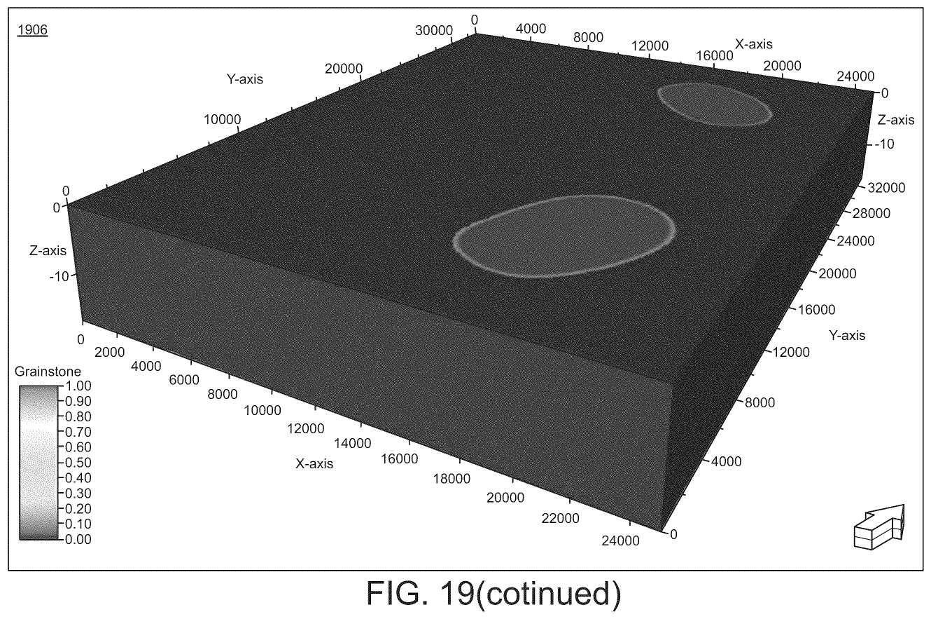

FIG. 19 shows 3D views 1900, 1902, 1904, 1906 of the distance-based facies trend models. The lateral shifting from bottom towards up is very clear for wackestone, mud-dominated packstone and grain-dominated packstone. The data processing system performs facies model building with the facies probabilities models. There are many algorithms available to integrate facies probability models, such as Truncated Gaussian Simulation (TGS), Sequential Indicator Simulation (SIS), and so on. For this example, the TGS was selected to build the facies model. The process for facies modeling includes simulating wackestone, mud-dominated packstone and grain-dominated packstone first. The grainstone facies is simulated separately, and other facies are treated as background for this simulation. The grainstone model is merged into the facies model generated from the other facies probabilities data.

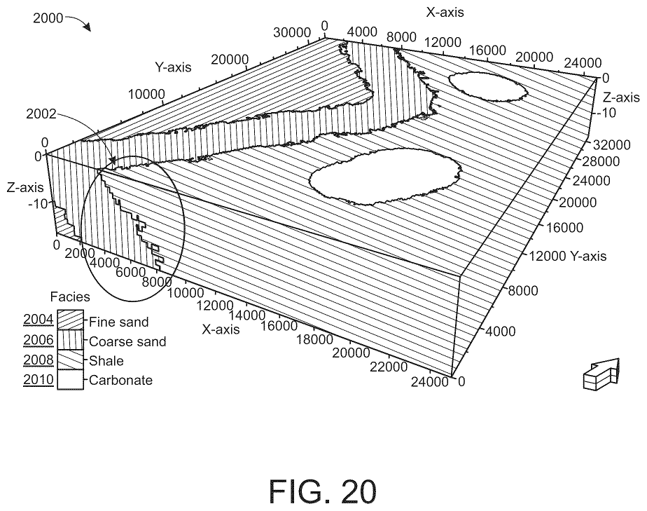

FIG. 20 shows a final facies model 2000. The facies model is very realistic, with the desired vertical trends. For example, the area 2002 shows vertical trends that are expected from geological stratification. Identified facies include fine sand 2004, coarse sand 2006, shale 2008, and carbonate 2010.

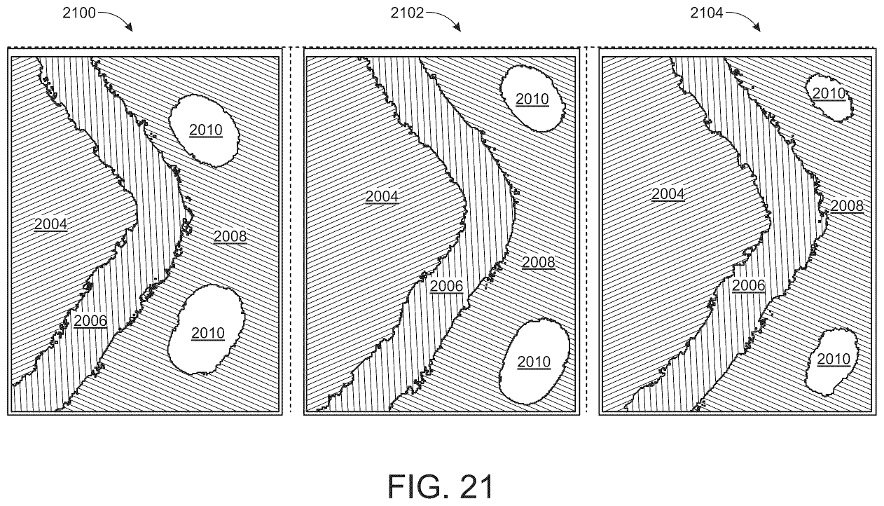

FIG. 21 shows example slices 2100, 2102, 2104 of the facies model 2000 representing facies including fine sand 2004, coarse sand 2006, shale 2008, and carbonate 2010 in area 100, 110. These are shown at different layers (e.g., of layers 1-17 described previously). Slice 2104 shows the facies model at the bottom of the grid, or at the earliest depositional time. Grainstone starts to grow at the same locations 2010, while other facies 2004, 2006, 2008 start to move towards the west, or deeper along the slope, as shown in slice 2102. All facies start to move towards the west after the layer of slice 2102, moving to the top of the grid (e.g., grid 400 of FIG. 4). Slice 2100 shows the facies model at the top of the grid 400, or at the latest depositional time. The facies model is checked for quality by confirming that the geological classifications conform to actual observations/well data in a test area.

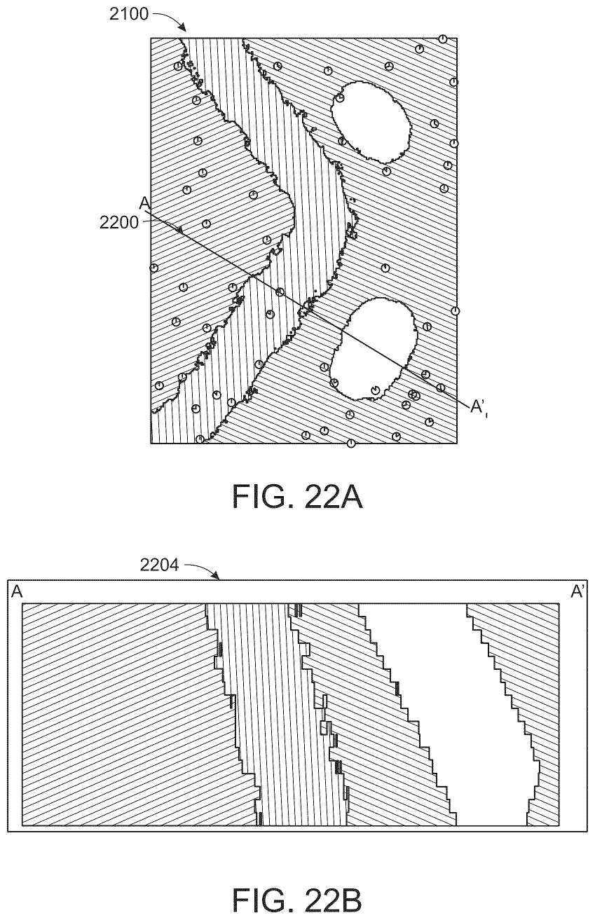

A cross section is created across all facies. FIG. 22A shows the slice 2100. The vertical cross-section location 2200 is made across the area 100, 110. FIG. 22B shows facies at the cross section. The facies evolution history is shown clearly on this vertical cross section.

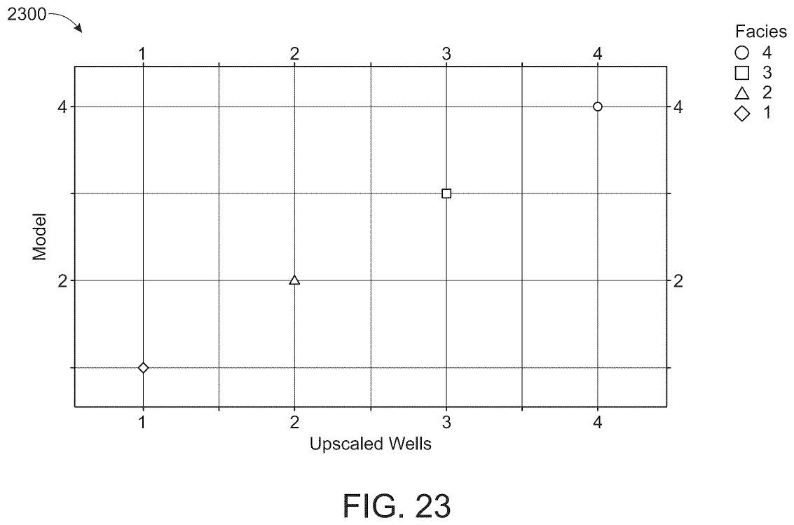

FIG. 23 shows a scatter plot 2300 of upscaled wells verses the model for validation of the model. All upscaled wells are honored. The model is validated against the well data. The facies model that includes stratification trends can be used to map locations for further well placement. In some implementations, the data processing system can control equipment in the field for drilling wells based on the generated facies model.

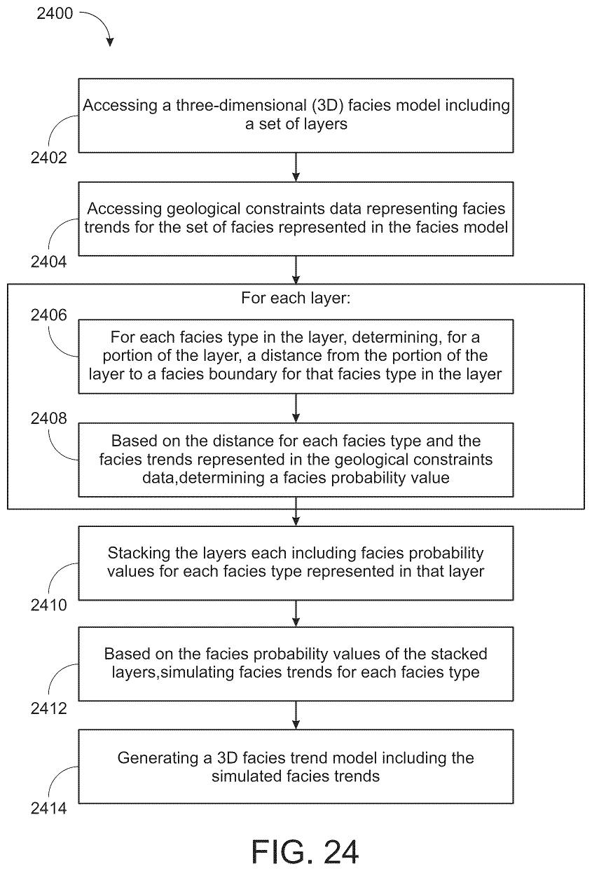

FIG. 24 illustrates a flow diagram for a process 2400 generating a facies trend model. The process 2400 can be performed by a data processing system as described herein. In some implementations, the process is for extracting hydrocarbons from a subsurface region. The process 2400 includes accessing (2402) a three-dimensional (3D) facies model including a set of layers, each layer including boundaries data representing initial facies boundaries for a set of facies represented in that layer. The process 2400 includes accessing (2404) geological constraints data representing facies trends for the set of facies represented in the facies model. The process 2400 includes, for each layer, and for each facies type in the layer, determining (2406), for a portion of the layer, a distance from the portion of the layer to a facies boundary for that facies type in the layer. The process 2400 includes, for each layer, and for each facies type in the layer, based on the distance for each facies type and the facies trends represented in the geological constraints data, determining (2406) a facies probability value. The process 2400 includes stacking (2408) the layers each including facies probability values for each facies type represented in that layer. The process 2400 includes, based on the facies probability values of the stacked layers, simulating (2410) facies trends for each facies type. The process 2400 includes generating (2414) a 3D facies trend model including the simulated facies trends.

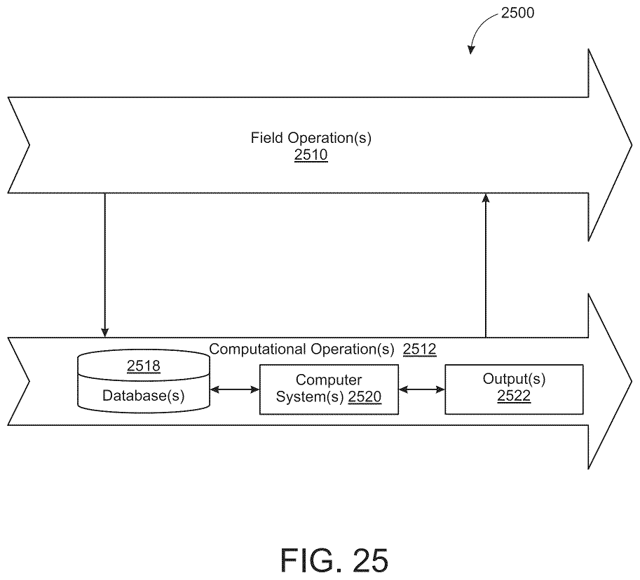

FIG. 25 illustrates hydrocarbon production operations 2500 that include both one or more field operations 2510 and one or more computational operations 2512, which exchange information and control exploration for the production of hydrocarbons. In some implementations, outputs of techniques of the present disclosure can be performed before, during, or in combination with the hydrocarbon production operations 2500, specifically, for example, either as field operations 2510 or computational operations 2512, or both.

Examples of field operations 2510 include forming/drilling a wellbore, hydraulic fracturing, producing through the wellbore, injecting fluids (such as water) through the wellbore, to name a few. In some implementations, methods of the present disclosure can trigger or control the field operations 2510. For example, the methods of the present disclosure can generate data from hardware/software including sensors and physical data gathering equipment (e.g., seismic sensors, well logging tools, flow meters, and temperature and pressure sensors). The methods of the present disclosure can include transmitting the data from the hardware/software to the field operations 2510 and responsively triggering the field operations 2510 including, for example, generating plans and signals that provide feedback to and control physical components of the field operations 2510. Alternatively or in addition, the field operations 2510 can trigger the methods of the present disclosure. For example, implementing physical components (including, for example, hardware, such as sensors) deployed in the field operations 2510 can generate plans and signals that can be provided as input or feedback (or both) to the methods of the present disclosure.

Examples of computational operations 2512 include one or more computer systems 2520 that include one or more processors and computer-readable media (e.g., non-transitory computer-readable media) operatively coupled to the one or more processors to execute computer operations to perform the methods of the present disclosure. The computational operations 2512 can be implemented using one or more databases 2518, which store data received from the field operations 2510 and/or generated internally within the computational operations 2512 (e.g., by implementing the methods of the present disclosure) or both. For example, the one or more computer systems 2520 process inputs from the field operations 2510 to assess conditions in the physical world, the outputs of which are stored in the databases 2518. For example, seismic sensors of the field operations 2510 can be used to perform a seismic survey to map subterranean features, such as facies and faults. In performing a seismic survey, seismic sources (e.g., seismic vibrators or explosions) generate seismic waves that propagate in the earth and seismic receivers (e.g., geophones) measure reflections generated as the seismic waves interact with boundaries between layers of a subsurface formation. The source and received signals are provided to the computational operations 2512 where they are stored in the databases 2518 and analyzed by the one or more computer systems 2520.

In some implementations, one or more outputs 2522 generated by the one or more computer systems 2520 can be provided as feedback/input to the field operations 2510 (either as direct input or stored in the databases 2518). The field operations 2510 can use the feedback/input to control physical components used to perform the field operations 2510 in the real world.

For example, the computational operations 2512 can process the seismic data to generate three-dimensional (3D) maps of the subsurface formation. The computational operations 2512 can use these 3D maps to provide plans for locating and drilling exploratory wells. In some operations, the exploratory wells are drilled using logging-while-drilling (LWD) techniques which incorporate logging tools into the drill string. LWD techniques can enable the computational operations 2512 to process new information about the formation and control the drilling to adjust to the observed conditions in real-time.

The one or more computer systems 2520 can update the 3D maps of the subsurface formation as information from one exploration well is received and the computational operations 2512 can adjust the location of the next exploration well based on the updated 3D maps. Similarly, the data received from production operations can be used by the computational operations 2512 to control components of the production operations. For example, production well and pipeline data can be analyzed to predict slugging in pipelines leading to a refinery and the computational operations 2512 can control machine operated valves upstream of the refinery to reduce the likelihood of plant disruptions that run the risk of taking the plant offline.

In some implementations of the computational operations 2512, customized user interfaces can present intermediate or final results of the above-described processes to a user. Information can be presented in one or more textual, tabular, or graphical formats, such as through a dashboard. The information can be presented at one or more on-site locations (such as at an oil well or other facility), on the Internet (such as on a webpage), on a mobile application (or app), or at a central processing facility.

The presented information can include feedback, such as changes in parameters or processing inputs, that the user can select to improve a production environment, such as in the exploration, production, and/or testing of petrochemical processes or facilities. For example, the feedback can include parameters that, when selected by the user, can cause a change to, or an improvement in, drilling parameters (including drill bit speed and direction) or overall production of a gas or oil well. The feedback, when implemented by the user, can improve the speed and accuracy of calculations, streamline processes, improve models, and solve problems related to efficiency, performance, safety, reliability, costs, downtime, and the need for human interaction.

In some implementations, the feedback can be implemented in real-time, such as to provide an immediate or near-immediate change in operations or in a model. The term real-time (or similar terms as understood by one of ordinary skill in the art) means that an action and a response are temporally proximate such that an individual perceives the action and the response occurring substantially simultaneously. For example, the time difference for a response to display (or for an initiation of a display) of data following the individual's action to access the data can be less than 1 millisecond (ms), less than 1 second(s) , or less than 5 s. While the requested data need not be displayed (or initiated for display) instantaneously, it is displayed (or initiated for display) without any intentional delay, based on processing limitations of a described computing system and time required to, for example, gather, accurately measure, analyze, process, store, or transmit the data.

Events can include readings or measurements captured by downhole equipment such as sensors, pumps, bottom hole assemblies, or other equipment. The readings or measurements can be analyzed at the surface, such as by using applications that can include modeling applications and machine learning. The analysis can be used to generate changes to settings of downhole equipment, such as drilling equipment. In some implementations, values of parameters or other variables that are determined can be used automatically (such as through using rules) to implement changes in oil or gas well exploration, production/drilling, or testing. For example, outputs of the present disclosure can be used as inputs to other equipment and/or systems at a facility. This can be especially useful for systems or various pieces of equipment that are located several meters or several miles apart or are located in different countries or other jurisdictions.

FIG. 26 is a block diagram of an example computing system 2600 used to provide computational functionalities associated with described algorithms, methods, functions, processes, flows, and procedures described in the present disclosure, according to some implementations of the present disclosure. The illustrated computer 2602 is intended to encompass any computing device such as a server, a desktop computer, a laptop/notebook computer, a wireless data port, a smart phone, a personal data assistant (PDA), a tablet computing device, or one or more processors within these devices, including physical instances, virtual instances, or both. The computer 2602 can include input devices such as keypads, keyboards, and touch screens that can accept user information. Also, the computer 2602 can include output devices that can convey information associated with the operation of the computer 2602. The information can include digital data, visual data, audio information, or a combination of information. The information can be presented in a graphical user interface (UI) (or GUI).

The computer 2602 can serve in a role as a client, a network component, a server, a database, a persistency, or components of a computer system for performing the subject matter described in the present disclosure. The illustrated computer 2602 is communicably coupled with a network 2624. In some implementations, one or more components of the computer 2602 can be configured to operate within different environments, including cloud-computing-based environments, local environments, global environments, and combinations of environments.

At a high level, the computer 2602 is an electronic computing device operable to receive, transmit, process, store, and manage data and information associated with the described subject matter. According to some implementations, the computer 2602 can also include, or be communicably coupled with, an application server, an email server, a web server, a caching server, a streaming data server, or a combination of servers.

The computer 2602 can receive requests over network 2624 from a client application (for example, executing on another computer 2602). The computer 2602 can respond to the received requests by processing the received requests using software applications. Requests can also be sent to the computer 2602 from internal users (for example, from a command console), external (or third) parties, automated applications, entities, individuals, systems, and computers.

Each of the components of the computer 2602 can communicate using a system bus 2604. In some implementations, any or all the components of the computer 2602, including hardware or software components, can interface with each other or the interface 2606 (or a combination of both), over the system bus 2604. Interfaces can use an application programming interface (API) 2614, a service layer 2616, or a combination of the API 2614 and service layer 2616. The API 2614 can include specifications for routines, data structures, and object classes. The API 2614 can be either computer-language independent or dependent. The API 2614 can refer to a complete interface, a single function, or a set of APIs.

The service layer 2616 can provide software services to the computer 2602 and other components (whether illustrated or not) that are communicably coupled to the computer 2602. The functionality of the computer 2602 can be accessible for all service consumers using this service layer. Software services, such as those provided by the service layer 2616, can provide reusable, defined functionalities through a defined interface. For example, the interface can be software written in JAVA, C++, or a language providing data in extensible markup language (XML) format. While illustrated as an integrated component of the computer 2602, in alternative implementations, the API 2614 or the service layer 2616 can be stand-alone components in relation to other components of the computer 2602 and other components communicably coupled to the computer 2602. Moreover, any or all parts of the API 2614 or the service layer 2616 can be implemented as child or sub-modules of another software module, enterprise application, or hardware module without departing from the scope of the present disclosure.

The computer 2602 includes an interface 2606. Although illustrated as a single interface 2606 in FIG. 26, two or more interfaces 2606 can be used according to needs, desires, or particular implementations of the computer 2602 and the described functionality. The interface 2606 can be used by the computer 2602 for communicating with other systems that are connected to the network 2624 (whether illustrated or not) in a distributed environment. Generally, the interface 2606 can include, or be implemented using, logic encoded in software or hardware (or a combination of software and hardware) operable to communicate with the network 2624. More specifically, the interface 2606 can include software supporting one or more communication protocols associated with communications. As such, the network 2624 or the hardware of the interface can be operable to communicate physical signals within and outside of the illustrated computer 2602.

The computer 2602 includes a processor 2608. Although illustrated as a single processor 2608 in FIG. 26, two or more processors 2608 can be used according to particular implementations of the computer 2602 and the described functionality. Generally, the processor 2608 can execute instructions and can manipulate data to perform the operations of the computer 2602, including operations using algorithms, methods, functions, processes, flows, and procedures as described in the present disclosure.

The computer 2602 also includes a database 2620 that can hold data (for example, well log data 2622) for the computer 2602 and other components connected to the network 2624 (whether illustrated or not). For example, database 2620 can be an in-memory, conventional, or a database storing data consistent with the present disclosure. In some implementations, database 2620 can be a combination of two or more different database types (for example, hybrid in-memory and conventional databases) according to particular implementations of the computer 2602 and the described functionality. Although illustrated as a single database 2620 in FIG. 26, two or more databases (of the same, different, or combination of types) can be used according to particular implementations of the computer 2602 and the described functionality. While database 2620 is illustrated as an internal component of the computer 2602, in alternative implementations, database 2620 can be external to the computer 2602.

The computer 2602 also includes a memory 2610 that can hold data for the computer 2602 or a combination of components connected to the network 2624 (whether illustrated or not). Memory 2610 can store any data consistent with the present disclosure. In some implementations, memory 2610 can be a combination of two or more different types of memory (for example, a combination of semiconductor and magnetic storage) according to implementations of the computer 2602 and the described functionality. Although illustrated as a single memory 2610 in FIG. 26, two or more memories 2610 (of the same, different, or combination of types) can be used according to implementations of the computer 2602 and the described functionality. While memory 2610 is illustrated as an internal component of the computer 2602, in alternative implementations, memory 2610 can be external to the computer 2602.

The application 2612 can be an algorithmic software engine providing functionality according to implementations of the computer 2602 and the described functionality. For example, application 2612 can serve as one or more components, modules, or applications. Further, although illustrated as a single application 2612, the application 2612 can be implemented as multiple applications 2612 on the computer 2602. In addition, although illustrated as internal to the computer 2602, in alternative implementations, the application 2612 can be external to the computer 2602.

The computer 2602 can also include a power supply 2618. The power supply 2618 can include a rechargeable or non-rechargeable battery that can be configured to be either user- or non-user-replaceable. In some implementations, the power supply 2618 can include power-conversion and management circuits, including recharging, standby, and power management functionalities. In some implementations, the power-supply 2618 can include a power plug to allow the computer 2602 to be plugged into a wall socket or a power source to, for example, power the computer 2602 or recharge a rechargeable battery.

There can be any number of computers 2602 associated with, or external to, a computer system containing computer 2602, with each computer 2602 communicating over network 2624. Further, the terms “client,” “user,” and other appropriate terminology can be used interchangeably, as appropriate, without departing from the scope of the present disclosure. Moreover, the present disclosure contemplates that many users can use one computer 2602 and one user can use multiple computers 2602.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Software implementations of the described subject matter can be implemented as one or more computer programs. Each computer program can include one or more modules of computer program instructions encoded on a tangible, non-transitory, computer-readable computer-storage medium for execution by, or to control the operation of, data processing apparatus. Alternatively, or additionally, the program instructions can be encoded in/on an artificially generated propagated signal. The example, the signal can be a machine-generated electrical, optical, or electromagnetic signal that is generated to encode information for transmission to suitable receiver apparatus for execution by a data processing apparatus. The computer-storage medium can be a machine-readable storage device, a machine-readable storage substrate, a random or serial access memory device, or a combination of computer-storage mediums.

Computer readable media (transitory or non-transitory, as appropriate) suitable for storing computer program instructions and data can include all forms of permanent/non-permanent and volatile/non-volatile memory, media, and memory devices. Computer readable media can include, for example, semiconductor memory devices such as random-access memory (RAM), read only memory (ROM), phase change memory (PRAM), static random-access memory (SRAM), dynamic random-access memory (DRAM), erasable programmable read-only memory (EPROM), electrically erasable programmable read-only memory (EEPROM), and flash memory devices. Computer readable media can also include, for example, magnetic devices such as tape, cartridges, cassettes, and internal/removable disks. Computer readable media can also include magneto optical disks and optical memory devices and technologies including, for example, digital video disc (DVD), CD ROM, DVD+/−R, DVD-RAM, DVD-ROM, HD-DVD, and BLURAY. The memory can store various objects or data, including caches, classes, frameworks, applications, modules, backup data, jobs, web pages, web page templates, data structures, database tables, repositories, and dynamic information. Types of objects and data stored in memory can include parameters, variables, algorithms, instructions, rules, constraints, and references. Additionally, the memory can include logs, policies, security or access data, and reporting files. The processor and the memory can be supplemented by, or incorporated in, special purpose logic circuitry.

Any claimed implementation is applicable to at least a computer-implemented method; a non-transitory, computer-readable medium storing computer-readable instructions to perform the computer-implemented method; and a computer system comprising a computer memory interoperable coupled with a hardware processor configured to perform the computer-implemented method or the instructions stored on the non-transitory, computer-readable medium.

While this specification contains many specific implementation details, these should not be construed as limitations on the scope of what may be claimed, but rather as descriptions of features that may be specific to implementations. Certain features that are described in this specification in the context of separate implementations can also be implemented, in combination, in a single implementation. Conversely, various features that are described in the context of a single implementation can also be implemented in multiple implementations, separately, or in any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

What is claimed is:

1. A method for geology-based facies trend modeling for extracting hydrocarbons from a subsurface region, the method comprising:
accessing a three-dimensional (3D) facies model including a set of layers, each layer including boundaries data representing initial facies boundaries for a set of facies represented in that layer;
accessing geological constraints data representing facies trends for the set of facies represented in the facies model;
for each layer:
for each facies type in the layer, determining, for a portion of the layer, a distance from the portion of the layer to a facies boundary for that facies type in the layer; and
based on the distance for each facies type and the facies trends represented in the geological constraints data, determining a facies probability value;
stacking the layers each including facies probability values for each facies type represented in that layer;
based on the facies probability values of the stacked layers, simulating facies trends for each facies type; and
generating a 3D facies trend model including the simulated facies trends.

2. The method of claim 1, further comprising generating the 3D facies model by performing operations comprising:
receiving, from a plurality of wells of a reservoir, well log data measured by sensors in each of the wells of the plurality of wells, the well log data representing porosity measurements of the subsurface region at each of the wells of the plurality, wherein at least a subset of the wells are associated with facies data representing facies at the subset of the wells;
determining, from the facies data, facies proportions associated with the subset of wells; and
based on the determined facies proportions at the plurality of wells, generating the 3D facies trend model for the subsurface region at each of the wells of the plurality.

3. The method of claim 2, wherein the subset of wells include cored wells from which facies data are directly measured.

4. The method of claim 2, further comprising:
generating, based on the 3D facies trend model, extended facies data for one or more wells of the plurality of wells that are not in the subset of wells that are associated with facies data.

5. The method of claim 4, wherein the extended facies data represent facies that are present at each of the plurality of wells.

6. The method of claim 1, further comprising:
determining, based on the 3D facies trend model, reservoir volumetrics data for the subsurface region; and
determining, based on the reservoir volumetrics data, a location in the subsurface region that includes hydrocarbon deposits.

7. The method of claim 6, further comprising:
drilling, at the location in the subsurface region, a well.

8. The method of claim 1, further comprising:
detecting, in the facies data of well log data, vertical trends in facies in the subsurface region;
generating vertical proportion curves from the vertical trends in the facies data; and
generating, based on the vertical proportion curves, the 3D facies model.

9. A system for geology-based facies trend modeling for extracting hydrocarbons from a subsurface region, the system comprising:
at least one processor; and
a memory storing instructions that, when executed by the at least one processor, cause the at least one processor to perform operations comprising:
accessing a three-dimensional (3D) facies model including a set of layers, each layer including boundaries data representing initial facies boundaries for a set of facies represented in that layer;
accessing geological constraints data representing facies trends for the set of facies represented in the facies model;
for each layer:
for each facies type in the layer, determining, for a portion of the layer, a distance from the portion of the layer to a facies boundary for that facies type in the layer; and
based on the distance for each facies type and the facies trends represented in the geological constraints data, determining a facies probability value;
stacking the layers each including facies probability values for each facies type represented in that layer;
based on the facies probability values of the stacked layers, simulating facies trends for each facies type; and
generating a 3D facies trend model including the simulated facies trends.

10. The system of claim 9, the operations further comprising generating the 3D facies model by:
receiving, from a plurality of wells of a reservoir, well log data measured by sensors in each of the wells of the plurality of wells, the well log data representing porosity measurements of the subsurface region at each of the wells of the plurality, wherein at least a subset of the wells are associated with facies data representing facies at the subset of the wells;
determining, from the facies data, facies proportions associated with the subset of wells; and
based on the determined facies proportions at the plurality of wells, generating the 3D facies trend model for the subsurface region at each of the wells of the plurality.

11. The system of claim 10, wherein the subset of wells include cored wells from which facies data are directly measured.

12. The system of claim 10, the operations further comprising:
generating, based on the 3D facies trend model, extended facies data for one or more wells of the plurality of wells that are not in the subset of wells that are associated with facies data.

13. The system of claim 12, wherein the extended facies data represent facies that are present at each of the plurality of wells.

14. The system of claim 9, the operations further comprising:
determining, based on the 3D facies trend model, reservoir volumetrics data for the subsurface region; and
determining, based on the reservoir volumetrics data, a location in the subsurface region that includes hydrocarbon deposits.

15. The system of claim 14, the operations further comprising:
drilling, at the location in the subsurface region, a well.

16. The system of claim 9, the operations further comprising:
detecting, in the facies data of well log data, vertical trends in facies in the subsurface region; and
generating vertical proportion curves from the vertical trends in the facies data; and
generating, based on the vertical proportion curves, the 3D facies model.

17. One or more non-transitory computer readable media storing instructions for geology-based facies trend modeling for extracting hydrocarbons from a subsurface region, the instructions, when executed by at least one processor, configured to cause the at least one processor to perform operations comprising:
accessing a three-dimensional (3D) facies model including a set of layers, each layer including boundaries data representing initial facies boundaries for a set of facies represented in that layer;
accessing geological constraints data representing facies trends for the set of facies represented in the facies model;
for each layer:
for each facies type in the layer, determining, for a portion of the layer, a distance from the portion of the layer to a facies boundary for that facies type in the layer; and
based on the distance for each facies type and the facies trends represented in the geological constraints data, determining a facies probability value;
stacking the layers each including facies probability values for each facies type represented in that layer;
based on the facies probability values of the stacked layers, simulating facies trends for each facies type; and
generating a 3D facies trend model including the simulated facies trends.

18. The one or more non-transitory computer readable media of claim 17, the operations further comprising generating the 3D facies model by:
receiving, from a plurality of wells of a reservoir, well log data measured by sensors in each of the wells of the plurality of wells, the well log data representing porosity measurements of the subsurface region at each of the wells of the plurality, wherein at least a subset of the wells are associated with facies data representing facies at the subset of the wells;
determining, from the facies data, facies proportions associated with the subset of wells; and
based on the determined facies proportions at the plurality of wells, generating the 3D facies trend model for the subsurface region at each of the wells of the plurality.

19. The one or more non-transitory computer readable media of claim 18,
wherein the subset of wells include cored wells from which facies data are directly measured.

20. The one or more non-transitory computer readable media of claim 18, the operations further comprising:
generating, based on the 3D facies trend model, extended facies data for one or more wells of the plurality of wells that are not in the subset of wells that are associated with facies data.
